(19) United States
(12) Patent Application Publication
(10) Pub. No.: US 2024/0324060 A1
(43) Pub. Date: Sep. 26, 2024

(54) RRM MEASUREMENT CONFIGURATION DETERMINING METHOD AND APPARATUS, COMMUNICATION DEVICE, AND STORAGE MEDIUM

(71) Applicant: Beijing Xiaomi Mobile Software Co., Ltd., Beijing (CN)

(72) Inventors: Yanhua LI, Beijing (CN); Ziquan HU, Beijing (CN)

(73) Assignee: Beijing Xiaomi Mobile Software Co., Ltd., Beijing (CN)

(21) Appl. No.: 18/575,395

(22) PCT Filed: Jul. 1, 2021
(86) PCT No.: PCT/CN2021/104065

§ 371 Date: Dec. 29, 2023

(51) Int. Cl. H04W 76/28; H04W 52/02

(52) U.S. Cl. CPC H04W 76/28; H04W 52/0216

(57) ABSTRACT

Examples of the disclosure provide an RRM measurement configuration determining method and apparatus, a communication device, and a storage medium. The radio resource management RRM measurement configuration determining method is executed by user equipment UE and includes: determining relevant information according to a non-connected state of the UE and an extended discontinuous reception eDRX configuration condition of the UE, where the relevant information at least indicates: a first DRX cycle and whether the UE has a first eDRX cycle; and determining a measurement configuration of the UE for RRM measurement according to the relevant information.

### CROSS REFERENCE TO RELATED APPLICATION

The present application is a U.S. National Stage of International Application No. PCT/CN2021/104065, filed on Jul. 1, 2021, the contents of all of which are incorporated herein by reference in their entireties for all purposes.

### BACKGROUND

An extended Discontinuous Reception (eDRX) mode is a working mode which is enhanced on a common Discontinuous Reception (DRX) mode and used for lowering the power consumption of user equipment (UE).

An inactive state is introduced to new radio (NR). The inactive state is a state between an idle state and a connected state, and usually, the inactive state is a UE state which is visible to a radio access network (RAN) but may be invisible to a core network (CN). Both the inactive state and the idle state belong to a non-connected state of the UE.

### SUMMARY

Examples of the disclosure provide a radio resource management (RRM) measurement configuration determining method and apparatus, an information processing method and apparatus, a communication device, and a storage medium.

A first aspect of the example of the disclosure provides an RRM measurement configuration determining method, executed by user equipment UE, and including: determining relevant information according to a non-connected state of the UE and an extended discontinuous reception eDRX configuration condition of the UE, where the relevant information at least indicates: a first DRX cycle and whether the UE has a first eDRX cycle; and determining a measurement configuration of the UE for RRM measurement according to the relevant information.

A second aspect of the example of the disclosure provides a communication device, including a processor, a transceiver, a memory and an executable program stored on the memory and capable of being operated by the processor. Where the RRM measurement configuration determining method of the first aspect is executed when the executable program is operated by the processor.

A third aspect of the example of the disclosure provides a computer storage medium which stores an executable program. The executable program can implement the RRM measurement configuration determining method provided by the first aspect above after being executed by a processor.

It should be understood that the above general descriptions and later detailed descriptions are merely explanatory and illustrative and cannot limit the examples of the disclosure.

### BRIEF DESCRIPTION OF THE DRAWINGS

The accompanying drawings here are incorporated into the specification and constitute a part of the specification, showing the principles consistent with the examples of the disclosure and used together with the specification to explain the examples of the disclosure.

FIG. 1 is a schematic structural diagram of a wireless communication system illustrated according to an example.

FIG. 2 is a schematic diagram of a time sequence for eDRX function execution illustrated according to an example.

FIG. 3 is a schematic interaction diagram of a core network configuring an idle state eDRX function illustrated according to an example.

FIG. 4 is a schematic flow diagram of RRM measurement configuration determination illustrated according to an example.

FIG. 5 is a schematic flow diagram of an RRM measurement configuration determining method illustrated according to an example.

FIG. 6 is a structural block diagram of an RRM measurement configuration determining apparatus illustrated according to an example.

FIG. 7 is a structural block diagram of UE illustrated according to an example.

FIG. 8 is a structural block diagram of a communication device illustrated according to an example.

### DETAILED DESCRIPTION

Examples will be described in detail here, and instances of the examples are shown in the accompanying drawings. When the following description refers to the accompanying drawings, unless otherwise indicated, the same numbers in different drawings indicate the same or similar elements. The embodiments described in the following examples do not represent all embodiments consistent with the examples of the disclosure. Rather, they are merely instances of apparatuses and methods consistent with some aspects of the examples of the disclosure as detailed in the appended claims.

The terms used in the examples of the disclosure are merely for the purpose of describing specific examples and are not intended to limit the examples of the disclosure. The singular forms “one” and “the” used in the examples of the disclosure and the appended claims are also intended to include the plural forms unless the context clearly indicates other meanings. It is also to be understood that the term “and/or” used here refers to and contains any or all possible combinations of one or more associated listed items.

It is to be understood that although the terms first, second, third, etc. may be used to describe various information in the examples of the disclosure, such information is not limited to these terms. These terms are merely used to distinguish the same type of information from each other. For example, without departing from the scope of the examples of the disclosure, first information may also be referred to as second information, and similarly, the second information may also be referred to as the first information. Depending on the context, the word “if” as used here may be interpreted as “at the time” or “when” or “in response to determining”.

The disclosure relates to but not limited to the technical field of wireless communication, in particular, to a radio resource management (RRM) measurement configuration determining method and apparatus, a communication device, and a storage medium. An eDRX cycle and a DRX cycle of a measurement configuration for RRM measurement (for short, RRM measurement configuration) are determined according to the non-connected state of the UE and the eDRX configuration condition. On the one hand, the RRM measurement configuration determined in this way can determine the measurement configuration meeting RRM measurement requirements, and on the other hand, controlling RRM measurement of the UE using such measurement configuration may also reduce the probability that the UE is in a sleep period of the eDRX cycle due to RRM measurement, reduces interruption of the sleep period of the UE caused by RRM measurement, and further saves the power consumption of the UE.

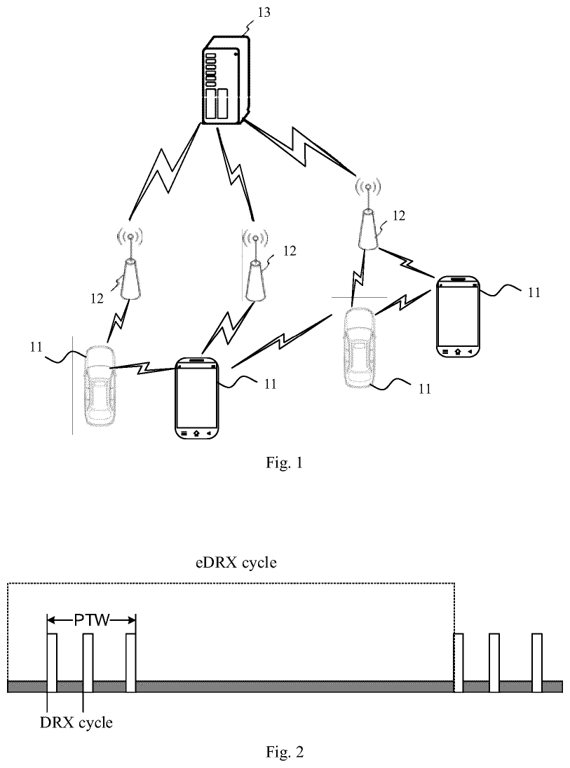

Referring to FIG. 1, a schematic structural diagram of a wireless communication system provided by an example of the disclosure is shown. As shown in FIG. 1, the wireless communication system is a communication system based on cellular mobile communication technology. The wireless communication system may include: a plurality of pieces of UE 11 and a plurality of access devices 12.

The UE 11 may refer to devices that provide a user with voice and/or data connectivity. The UE 11 may communicate with one or more core networks via a radio access network (RAN). The UE 11 may be internet of things UE, such as sensor devices, mobile phones (or called “cellular” phones) and computers with internet of things UE. For example, the UE may be fixed, portable, pocket-size, handheld, computer built-in or vehicle-mounted apparatuses. For example, the UE may be stations (STAs), subscriber units, subscriber stations, mobile stations, mobiles, remote stations, access points, remote UE (remote terminals), access UE (access terminals), user terminals, user agents, user devices, or user equipment (UE). The UE 11 may also be unmanned aircraft devices. The UE 11 may also be vehicle-mounted devices, such as a trip computer with a wireless communication function, or a wireless communication device connected with an external trip computer. The UE 11 may also be roadside devices, such as a street lamp, a signal light or other roadside devices with wireless communication functions.

The access devices 12 may be network side devices in the wireless communication system. The wireless communication system may be the 4th generation mobile communication (4G) system, also called a long-term evolution (LTE) system. The wireless communication system may also be a 5G system, also called a new radio (NR) system or 5G NR system. The wireless communication system may also be a next-generation system of the 5G system. An access network in the 5G system may be called a new generation-radio access network (NG-RAN), or, it is a machine type communication (MTC) system.

The access devices 12 may be evolved access devices (eNB) adopted in the 4G system. The access devices 12 may also be access devices adopting centralized and distributed architectures (gNB) in the 5G system. When the access devices 12 adopt the centralized and distributed architectures, they typically each include a central unit (CU) and at least two distributed units (DUs). Protocol stacks of a packet data convergence protocol (PDCP) layer, a radio link control (RLC) layer and a media access control (MAC) layer are disposed in the central unit; and protocol stacks of physical (PHY) layers are disposed in the distributed units, and specific embodiments of the access devices 12 are not limited in the example of the disclosure.

The access devices 12 and the UE 11 may establish wireless connection through wireless radio. In different embodiments, the wireless radio is a wireless radio based on the 4G standard; or, the wireless radio is a wireless radio based on the 5G standard, such as new radio; or, the wireless radio may also be a wireless radio based on the next-generation mobile communication standard of 5G.

In some examples, the UE 11 may also establish end to end (E2E) connections. For example, vehicle to vehicle (V2V) communication, vehicle to infrastructure (V2I) communication and vehicle to pedestrian (V2P) communication in vehicle to everything (V2X) communication and other scenarios.

In some examples, the above wireless communication system may further contain a network management device 13.

The plurality of access devices 12 are connected with the network management device 13. The network management device 13 may be a core network device in the wireless communication system, for example, the network management device 13 may be a mobility management entity (MME) in an evolved packet core (EPC). Or, the network management device 13 may also be other core network devices, such as a serving gateway (SGW), a public data network gateway (PGW), a policy and charging rules function (PCRF) or a home subscriber server (HSS). The embodiment form of the network management device 13 is not limited in the examples of the disclosure.

The UE will enter into an eDRX mode after starting an eDRX function. The UE in the eDRX mode has the following characteristics: the UE is accessible at any time, but accessible delay is large, and the time delay depends on an eDRX cycle configuration.

As such, the UE with the eDRX function started achieves the balance between power consumption and data transmission timeliness of the UE to the maximum extent.

The eDRX function has one or more of the following eDRX parameters: a starting time domain position of a paging time window (PTW); a length of a PTW; and an eDRX cycle, which may be represented by T eDRX. H.

FIG. 2 shows a sequence diagram after the eDRX function is started by the UE.

It can be known by referring to FIG. 2 that: a PTW is in one eDRX cycle; and the PTW has one or more DRX cycles. A duration of each DRX cycle may be far shorter than a duration of the eDRX cycle. For example, the duration of a DRX cycle may be 2.56s, while the duration of an eDRX cycle may be 10.24s.

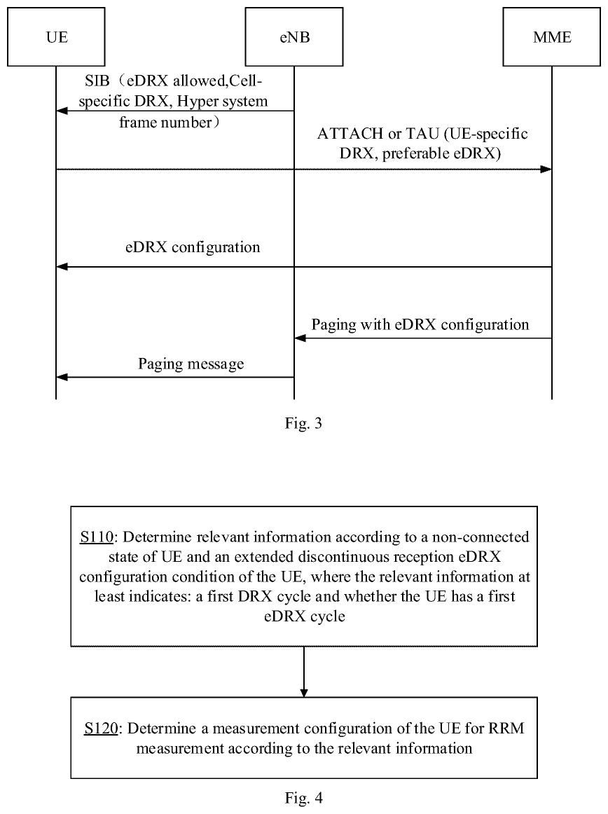

FIG. 3 is a schematic interaction diagram that shows the UE and a core network interacting in terms of one of the eDRX parameters of the eDRX function. A method for interaction of the eDRX parameter between the UE and the core network shown in FIG. 3 may include the following.

eNB sends to the UE an indication of an allowed eDRX function, cell-specific DRX and a hyper system frame number (SFN) through a system information block (SIB).

The UE sends UE-specific DRX and/or preferable eDRX under an attach request or a tracking area update (TAU) request to the MME.

After receiving the above-mentioned attach request or the TAU request, the MME issues an eDRX configuration to the UE. The aforementioned one or more eDRX parameters are carried in the eDRX configuration.

The MME performs paging according to the eDRX configuration. After receiving a core network (CN) paging message issued by the MME, the eNB forwards the CN paging message to the UE.

The eDRX parameter issued by the core network is transmitted to the UE in an unvarnished manner through a base station (such as an evolved base station (eNB) or a next-generation base station (gNB)). For example, the mobile management entity (MME) of the core network sends the eDRX parameter of the eDRX function to the UE through the eNB.

A radio resource control (RRC) idle state, also referred herein as an idle state, is a low power consumption state of the UE which is transparent to the core network.

An RRC inactive state is also referred herein as an inactive state. The inactive state is a low power consumption state of the UE which is transparent to the core network. However, the inactive state is visible to an access network.

If the UE enters into the inactive state, the UE needs to receive a paging message sent by the CN (namely the CN paging message), and further needs to receive a paging message sent by a radio access network (RAN), namely an RAN paging message.

As shown in FIG. 4, an example of the disclosure provides an RRM measurement configuration determining method. The method is executed by user equipment UE, and includes steps S110 and S120.

S110: determining relevant information according to a non-connected state of the UE and an extended discontinuous reception eDRX configuration condition of the UE. The relevant information at least indicates: a first DRX cycle and whether the UE has a first eDRX cycle.

S120: determining a measurement configuration of the UE for RRM measurement according to the relevant information.

The non-connected state here includes: an idle state and/or an inactive state.

The UE includes but is not limited to using new radio (NR) UE. The NR UE may be UE using NR carriers.

In the example of the disclosure, the relevant information about the first DRX cycle and the first eDRX cycle determined for performing RRM measurement will be determined according to the non-connected state of the UE and the eDRX configuration condition of the UE.

It is worth noting that, “first” in the first DRX cycle and the first eDRX cycle itself has no particular meaning, but the entire phrase “first DRX cycle” and the “first eDRX cycle” refer specifically to a DRX cycle and an eDRX cycle used to determine RRM measurement.

The relevant information has at least one of the following: first DRX cycle information, at least indicating the first DRX cycle used for determining the measurement configuration for RRM measurement; or first eDRX cycle information, including but not limited to: indicating whether the first eDRX cycle is provided, or indicating a duration of the first eDRX cycle when the first eDRX cycle is provided.

The first DRX cycle information may include: one or more bits, indicating a duration of the first DRX cycle, for example, the one or more bits indicate a duration identification of the duration of the first DRX cycle; and one or more bits, indicating that the first DRX cycle is equal to any one of an idle state DRX cycle, an RAN paging cycle or a default paging cycle.

For example, the first eDRX cycle information includes a duration value, if the duration value is 0, it represents that the UE does not have the first eDRX cycle, and if the duration value is not 0, it represents that the UE has the first eDRX cycle and the duration of the first eDRX cycle is the duration value.

For another example, the first eDRX cycle information may contain two bits, where one bit corresponds to an idle state eDRX cycle of the UE, and the other bit corresponds to an inactive state eDRX cycle of the UE. The first eDRX cycle may be one of the idle state eDRX cycle and the inactive state eDRX cycle of the UE, and then a corresponding bit value in the two bits is used as a preset value, indicating that the first eDRX cycle of the current UE is equal to the idle state eDRX cycle or the inactive state eDRX cycle corresponding to the bit with the bit value being the preset value. If only one of the bit values of the two bits is the preset value, and both the bit values of the two bits are not the preset value, it may be considered that the current UE does not have the first eDRX cycle.

As previously noted, this is merely an example of the information content and the information description manner of the relevant information, and it is not limited to this during specific embodiment.

In the example of the disclosure, the measurement configuration for RRM measurement includes but is not limited to at least one of the following: a measurement configuration for a serving cell of the UE; a measurement configuration for an intra-frequency neighboring cell of the UE; a measurement configuration for an inter-frequency neighboring cell of the UE; or a measurement configuration for an inter-system cell of the UE.

The measurement configuration for the serving cell at least includes: a measurement cycle.

The measurement configuration for the intra-frequency neighboring cell, the measurement configuration for the inter-frequency neighboring cell and the measurement configuration for the inter-system cell may each include: one or more of a detection cycle, a measurement cycle and an evaluation cycle. The detection cycle may be used for the UE to recognize a neighboring cell and evaluate the recognized neighboring cell. The measurement cycle is used for non-first measurement of the neighboring cell after the corresponding neighboring cell is recognized. The evaluation cycle may evaluate the neighboring cell based on a measurement result after the neighboring cell is recognized.

Generally, the detection cycle is greater than the measurement cycle and greater than the evaluation cycle, and the evaluation cycle is greater than the measurement cycle.

Within the measurement cycle, the UE will measure a synchronization signal and PBCH block (SSB) of the neighboring cell. PBCH stands for Physical Broadcast Channel.

The measurement configurations for the intra-frequency neighboring cell and the inter-frequency neighboring cell of the UE may be the same or different.

When the measurement configuration for RRM measurement is determined according to the relevant information, the measurement configuration for RRM measurement may be determined according to a correspondence relationship between measurement configurations and configuration conditions of first eDRX cycles and between the measurement configurations and first DRX cycles.

For example, the UE may receive a configuration table, in which the above-mentioned correspondence relationship is defined, such that in S120, the table may be queried according to the relevant information to obtain the measurement configuration for RRM measurement.

In the example of the disclosure, the relevant information is determined according to the non-connected state of the UE and the eDRX configuration condition, so as to obtain whether the UE has the first eDRX cycle and the first DRX cycle. In this way, the measurement configuration for RRM measurement suitable for the state and eDRX configuration of the current UE may be determined according to the non-connected state of the UE and the eDRX configuration condition that has been configured for the UE, and thus power consumption caused by the fact that the UE in the eDRX mode still exits from a sleep state frequently to perform RRM measurement due to RRM measurement because of an inappropriate measurement configuration for RRM measurement is reduced, and the power consumption of the UE is further saved.

The current non-connected state of the UE may be the idle state or the inactive state. An eDRX cycle configured by a network side for the UE may be the idle state eDRX cycle or the inactive state eDRX cycle. Certainly, the UE may be configured with any one or two of the idle state eDRX cycle and the inactive state eDRX cycle, and may also be not configured with the idle state eDRX cycle or the inactive state eDRX cycle.

As a result, in this case, the non-connected state of the UE and the eDRX configuration condition may be subdivided into many cases, which are described respectively.

A second cycle, a third cycle and a first cycle will be involved in the following description, for example, the second cycle may be a cycle with a duration of 10.24 s, the third cycle may be a cycle with a duration of 5.12 s, and the first cycle may be a cycle with a duration of 2.56 s.

In a word, in the example of the disclosure, in S110, the first DRX cycle of the UE and whether the UE has the first eDRX cycle will be determined according to the non-connected state of the UE and the eDRX configuration condition.

### Case A

In response to that the UE is in the idle state, the idle state eDRX cycle of the UE is configured as the first cycle and at least one of the UE and/or an anchor base station of the UE does not support the idle state eDRX cycle which is the first cycle.

At the moment, it may be determined that the UE does not have the first eDRX cycle, and the first DRX cycle is equal to the idle state eDRX cycle.

The UE does not have the first eDRX cycle, while the first DRX cycle of the UE may be equal to the idle state eDRX cycle.

For example, if the network side (core network and/or access network) configures the idle state eDRX cycle of the UE as the first cycle, but one or more of the UE and/or the anchor base station (or called serving base station) connected with the UE do not support the idle state eDRX cycle to be the first cycle, then at the moment, it may be affirmed that the UE in the idle state does not have the first eDRX cycle, and the first eDRX cycle may be equal to the idle state eDRX cycle configured by the network side.

In some examples, the first cycle may be a minimum eDRX cycle supported by the eDRX mode. For example, the first cycle may be an eDRX cycle with a duration of 2.56 s under the eDRX mode.

### Case B:

In response to that the UE is in the inactive state, the inactive state eDRX cycle of the UE is configured as the first cycle and at least one of the UE and/or the anchor base station of the UE does not support the inactive state eDRX cycle which is the first cycle, at the moment, it may be considered that the UE does not have the first eDRX cycle, and the first DRX cycle is equal to the inactive state eDRX cycle.

In Case B, the UE in the inactive state does not have the first eDRX cycle, while the first DRX cycle of the UE may be equal to the inactive state eDRX cycle.

For another example, if the network side (core network and/or access network) configures the inactive state eDRX cycle of the UE as the first cycle, but one or more of the UE and/or the anchor base station (or called serving base station) connected with the UE do not support the inactive state eDRX cycle to be the first cycle, then at the moment, it may be affirmed that the UE in the inactive state does not have the first eDRX cycle, and the first eDRX cycle may be equal to the inactive state eDRX cycle configured by the network side.

### Case C:

In response to that the UE is in the inactive state, the idle state eDRX cycle of the UE is not greater than the second cycle and the inactive state eDRX cycle of the UE is not configured.

In Case C, the UE does not have the first eDRX cycle, and the first DRX cycle is determined according to an idle state eDRX configuration of the UE.

For example, the first DRX cycle of the UE may be: an idle state DRX cycle defined by the idle state eDRX configuration; or the first DRX cycle is equal to a smaller one of the idle state eDRX cycle and a radio access network RAN paging cycle.

As the UE is in the inactive state and the UE is not configured with the inactive state eDRX cycle, an RRM configuration of the UE in the inactive state may not have the first eDRX cycle, instead, the measurement configuration for RRM measurement is determined merely according to the first DRX cycle.

At the moment, the first DRX cycle may be: a cycle in which the UE enters into the DRX mode in the inactive state, and it may be the idle state DRX cycle or the RAN paging cycle in the inactive state.

As a result, configuring the first DRX cycle as the idle state DRX cycle or the RAN paging cycle may be related to a current cycle of the inactive-state UE.

### Case D:

The UE is in the idle state, the idle state eDRX cycle of the UE is not greater than the second cycle and the inactive state eDRX cycle of the UE is not configured. In Case D, it may be considered that the UE has the first eDRX cycle which is equal to the idle state eDRX cycle, and the first DRX cycle is determined according to the idle state eDRX configuration of the UE.

The UE is in the idle state, and then the UE will enter into the eDRX mode according to the idle state eDRX cycle, so that the idle state eDRX cycle may be determined as the first eDRX cycle, and the first DRX cycle is further determined according to the idle state eDRX cycle.

The idle state eDRX cycle is not greater than the second cycle, that is, the eDRX cycle may be the first cycle to the third cycle.

The first cycle is smaller than the third cycle, and the third cycle is smaller than the second cycle.

For example, it is assumed that the duration of the first cycle is 2.56 s, the duration of the third cycle is 5.12 s, and the duration of the second cycle is 10.24 s.

For example, the first DRX cycle may be equal to the idle state eDRX cycle. For another example, the first DRX cycle is equal to the first cycle or the third cycle.

### Case E:

The UE is in the inactive state, the UE is configured with the idle state eDRX cycle and the inactive state eDRX cycle, and both the idle state eDRX cycle and the inactive state eDRX cycle are not greater than the second cycle.

In Case E, the first eDRX cycle of the UE may be at least one of the following: the first eDRX cycle is: a smaller one of the inactive state eDRX cycle and the idle state eDRX cycle; or the first eDRX cycle is: the inactive state eDRX cycle.

The first DRX cycle of the UE may be: any one of the first cycle to the third cycle.

For example, the first DRX cycle is determined according to the first eDRX cycle. For example, the first DRX cycle may be equal to the first eDRX cycle, or, the first DRX cycle may be any eDRX cycle which corresponds to any eDRX mode and is smaller than or equal to the first eDRX cycle.

### Case F:

In response to that the UE is in the idle state, the idle state eDRX cycle of the UE is greater than the second cycle and the inactive state eDRX cycle is not configured.

In Case F, the condition of the first eDRX cycle of the UE may be as follows: it may be determined that the UE does not have the first eDRX cycle; or, it may be determined that the UE has the first eDRX cycle which is equal to the idle state eDRX cycle.

The first DRX cycle of the UE may be at least one of the following: the first DRX cycle is equal to the idle state eDRX cycle; the first DRX cycle is equal to the RAN paging cycle; the first DRX cycle is equal to a smaller one of the idle state eDRX cycle and the RAN paging cycle; or a smallest one of the idle state DRX cycle defined by the idle state eDRX configuration, an RAN paging cycle defined by an inactive state eDRX configuration, and the default paging cycle.

In some examples, if the idle state eDRX cycle of the UE is greater than the second cycle, then the idle state eDRX cycle of the UE has a PTW, and if the idle state eDRX cycle is configured as the first eDRX cycle, then measurement time of RRM measurement may be limited within the PTW of the idle state eDRX cycle.

### Case G:

The UE is in the inactive state, the idle state eDRX cycle of the UE is greater than the second cycle and the inactive state eDRX cycle is not configured.

In Case G, the first eDRX cycle of the UE may be equal to the idle state eDRX cycle. The first DRX cycle of the UE may be determined according to the idle state eDRX configuration.

For example, the first DRX cycle may be at least one of the following: the first DRX cycle is a smaller one of the idle state DRX cycle defined by the idle state eDRX configuration and the default paging cycle; or the first DRX cycle is the idle state DRX cycle defined by the idle state eDRX configuration.

The first DRX cycle may further be: a smallest one of the idle state DRX cycle defined by the idle state eDRX configuration, the RAN paging cycle defined by the inactive state eDRX configuration, and the default paging cycle.

In some examples, if the idle state eDRX cycle of the UE is greater than the second cycle, then the idle state eDRX cycle of the UE has a PTW, and if the idle state eDRX cycle is configured as the first eDRX cycle, then measurement time of RRM measurement may be limited within the PTW of the idle state eDRX cycle.

### Case H:

The UE is in the idle state, the idle state eDRX cycle of the UE is greater than the second cycle and the inactive state eDRX cycle not greater than the second cycle is configured.

In Case H, it may be considered that the UE has the first eDRX cycle which is equal to the idle state eDRX cycle.

At the moment, the measurement time of RRM measurement may be located within the PTW of the idle state eDRX cycle.

The first DRX cycle may be determined according to the idle state eDRX configuration, and may be specifically at least one of the following: a DRX cycle defined by the idle state eDRX configuration; or the first DRX cycle is a smaller one of an eDRX cycle defined by the idle state eDRX configuration and the default paging cycle.

### Case J:

The UE is in the inactive state, the idle state eDRX cycle of the UE is greater than the second cycle and the inactive state eDRX cycle not greater than the second cycle is configured.

In Case J, the first eDRX cycle of the UE may be one of the following: the first eDRX cycle is equal to the idle state eDRX cycle; or the first eDRX cycle is equal to a smaller one of the idle state eDRX cycle and the inactive state eDRX cycle.

At the moment, if the first eDRX cycle is equal to the idle state eDRX cycle, then the first DRX cycle of the UE may be one of the following: the first DRX cycle is the idle state DRX cycle defined by the idle state eDRX configuration; or the first DRX cycle is a smaller one of the idle state DRX cycle defined by the idle state eDRX configuration and the default paging cycle.

If the first eDRX cycle is equal to a smaller one of the idle state eDRX cycle and the inactive state eDRX cycle, then the first DRX cycle may be one of the following: the first DRX cycle is a smaller one of the idle state DRX cycle defined by the idle state eDRX configuration and the default paging cycle; the first DRX cycle is a smallest one of the idle state DRX cycle defined by the idle state eDRX configuration, the RAN paging cycle defined by the inactive state eDRX configuration, and the default paging cycle; or the first DRX cycle is a smaller one of the idle state DRX cycle defined by the idle state eDRX configuration and the RAN paging cycle defined by the inactive state eDRX configuration.

In some examples, if the idle state eDRX cycle greater than the second cycle is used as the first eDRX cycle, then the measurement time of RRM measurement is located within the PTW of the idle state eDRX cycle, otherwise the measurement time of RRM measurement may be located within a whole-time domain.

### Case I:

The UE is in the idle state, the idle state eDRX cycle of the UE is greater than the second cycle and the inactive state eDRX cycle greater than the second cycle is configured.

In Case I, it may be considered that the UE has the first eDRX cycle which is equal to the idle state eDRX cycle.

At the moment, the measurement time of RRM measurement is located within the PTW of the idle state eDRX cycle greater than the second cycle.

The first DRX cycle of the UE may be determined according to the idle state eDRX configuration, and may be specifically at least one of the following:

the first DRX cycle is a smaller one of the idle state DRX cycle defined by the idle state eDRX configuration and the default paging cycle; or the first DRX cycle may be the idle state DRX cycle defined by the idle state eDRX configuration.

### Case L:

The UE is in the inactive state, the idle state eDRX cycle of the UE is greater than the second cycle and the inactive state eDRX cycle greater than the second cycle is configured.

The first eDRX cycle of the UE may be at least one of the following: the first eDRX cycle may be the idle state eDRX cycle; the first eDRX cycle may be the inactive state eDRX cycle; or the first eDRX cycle may be a smaller one of the idle state eDRX cycle and the inactive state eDRX cycle.

If the first eDRX cycle is equal to the idle state eDRX cycle, then the measurement time of RRM measurement of the UE is located within the PTW of the idle state eDRX cycle. If the first eDRX cycle is equal to the inactive state eDRX cycle, then the measurement time of RRM measurement of the UE is located within a PTW of the inactive state eDRX cycle.

The UE has the first eDRX cycle which is equal to the idle state eDRX cycle, and then the first DRX cycle of the UE may be as follows: an idle state DRX cycle defined by the idle state eDRX configuration; a smaller one of the RAN paging cycle defined by the inactive state eDRX configuration and the default paging cycle; or a smallest one of the idle state DRX cycle defined by the idle state eDRX configuration, the RAN paging cycle defined by the inactive state eDRX configuration, and the default paging cycle.

If the UE has the first eDRX cycle which is equal to the inactive state eDRX cycle, then the first DRX cycle of the UE may be as follows: the RAN paging cycle defined by the inactive state eDRX configuration; a smallest one of the idle state DRX cycle defined by the idle state eDRX configuration, the default paging cycle and the RAN paging cycle defined by the inactive state eDRX configuration; or a smaller one of the default paging cycle and the RAN paging cycle defined by the inactive state eDRX configuration.

If the UE has the first eDRX cycle which is equal to the smaller one of the idle state eDRX cycle and the inactive state eDRX cycle, then the first DRX cycle of the UE may be as follows: the first DRX cycle is a smallest one of the idle state DRX cycle defined by the idle state eDRX configuration, the default paging cycle and the RAN paging cycle defined by the inactive state eDRX configuration; the first DRX cycle is a smaller one of the default paging cycle and the RAN paging cycle defined by the inactive state eDRX configuration; or the first DRX cycle is a smaller one of the default paging cycle and the idle state DRX cycle defined by the idle state eDRX configuration.

If the UE has the first eDRX cycle which is equal to the smaller one of the idle state eDRX cycle and the inactive state eDRX cycle, then the time of RRM measurement is located within a smaller one of the PTW of the idle state eDRX cycle and the PTW of the inactive state eDRX cycle.

In any one of the above cases, if it is not particularly defined that RRM measurement of the UE is located within a certain PTW, then it may be considered that RRM measurement is located in the whole time domain.

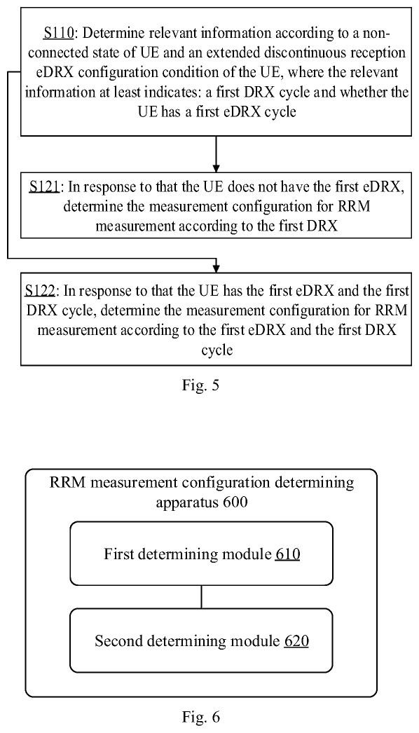

In some examples, as shown in the flow chart of FIG. 5, S120 may include steps S121 and S122. The details of S110 not repeated.

S121: in response to the UE not having the first eDRX cycle, determining the measurement configuration for RRM measurement according to the first DRX cycle.

S121 has many specific implementing manners, when the UE does not have the first eDRX cycle, the measurement configuration is determined according to the first DRX cycle alone, and the measurement configuration includes but is not limited to: a measurement configuration for RRM measurement of a serving cell and/or a measurement configuration for RRM measurement of a neighboring cell. The neighboring cell includes but is not limited to: an intra-frequency neighboring cell and/or an inter-frequency neighboring cell and/or an inter-system neighboring cell.

For example, the measurement configuration may be determined according to one or more elements in Table 1:

TABLE 1
Nserv for UE configured with an idle state DRX
cycle, where Nserv is the number of DRX cycles

| | | |
|---|---|---|
| Duration of | Scaling factor (N1) | Nserv [number |

| | DRX cycle [s] | FR1 | FR2^{Note1} | of DRX cycles] |
|---|---|---|---|---|
| [symbol] | 0.32 | 1 | 8 | M1*N1*4 |
| | 0.64 | | 5 | M1*N1*4 |
| | 1.28 | | 4 | N1*2 |
| | 2.56 | | 3 | N1*2 |

Detection cycle (Tdetect), measurement cycle Tmeasure and evaluation cycle (Tevaluate)
of intra-frequency neighboring cell of UE configured with idle state DRX cycle

| | | | | Detection | Measurement | Evaluation |
|---|---|---|---|---|---|---|
| | Duration | Scaling | | cycle [s] | cycle [s] | cycle [s] |
| | of DRX | factor (N1) | | (number of | (number of | (number of |
| | cycle [s] | FR1 | FR2^{Note1} | DRX cycles) | DRX cycles) | DRX cycles) |
| [symbol] | 0.32 | 1 | 8 | 11.52 × N1 × M2 | 1.28 × N1 × M2 | 5.12 × N1 × M2 |
| | | | | (36 × N1 × M2) | (4 × N1 × M2) | (16 × N1 × M2) |
| | 0.64 | | 5 | 17.92 × N1 | 1.28 × N1 | 5.12 × N1 |
| | | | | (28 × N1) | (2 × N1) | (8 × N1) |
| | 1.28 | | 4 | 32 × N1 | 1.28 × N1 | 6.4 × N1 |
| | | | | (25 × N1) | (1 × N1) | (5 × N1) |
| | 2.56 | | 3 | 58.88 × N1 | 2.56 × N1 | 7.68 × N1 |
| | | | | (23 × N1) | (1 × N1) | (3 × N1) |

Detection cycle (Tdetect), measurement cycle Tmeasure and evaluation cycle (Tevaluate)
of inter-frequency neighboring cell of UE configured with idle state DRX cycle

| | | | | Detection | Measurement | Evaluation |
|---|---|---|---|---|---|---|
| | Duration | Scaling | | cycle [s] | cycle [s] | cycle [s] |
| | of DRX | factor (N1) | | (number of | (number of | (number of |
| | cycle [s] | FR1 | FR2^{Note1} | DRX cycles) | DRX cycles) | DRX cycles) |
| [symbol] | 0.32 | 1 | 8 | 11.52 × N1 × 1.5 | 1.28 × N1 × 1.5 | 5.12 × N1 × 1.5 |
| | | | | (36 × N1 × 1.5) | (4 × N1 × 1.5) | (16 × N1 × 1.5) |
| | 0.64 | | 5 | 17.92 × N1 | 1.28 × N1 | 5.12 × N1 |
| | | | | (28 × N1) | (2 × N1) | (8 × N1) |
| | 1.28 | | 4 | 32 × N1 | 1.28 × N1 | 6.4 × N1 |
| | | | | (25 × N1) | (1 × N1) | (5 × N1) |
| | 2.56 | | 3 | 58.88 × N1 | 2.56 × N1 | 7.68 × N1 |
| | | | | (23 × N1) | (1 × N1) | (3 × N1) |

Detection cycle (Tdetect), measurement cycle Tmeasure and evaluation
cycle (Tevaluate) of inter-system neighboring cell of UE configured
with idle state DRX cycle

| | | Detection | | Measurement | Evaluation | |
|---|---|---|---|---|---|---|
| | Duration | cycle [s] | | cycle [s] | cycle [s] | |
| | of DRX | (number of | | (number of | (number of | |
| | cycle [s] | DRX cycles) | | DRX cycles) | DRX cycles) | |
| [symbol] | 0.32 | 11.52 | (36) | 1.28 (4) | 5.12 | (16) |
| | 0.64 | 17.92 | (28) | 1.28 (2) | 5.12 | (8) |
| | 1.28 | 32 | (25) | 1.28 (1) | 6.4 | (5) |
| | 2.56 | 58.88 | (23) | 2.56 (1) | 7.68 | (3) |

^{Note1}:
supporting power classes 2, 3 and 4 to use values of N1 corresponding to FR1 and FR2. UE supporting power class 1 uses N1 = 8
Note 2:
if an SMTC cycle used for measurement of an intra-frequency cell is greater than 20 ms, M2 = 1.5, otherwise, M2 = 1 if different cells are configured with different SMTC time periods. The SMTC cycle in this note is the one used by the cell being identified. During PSS/SSS detection, it is assumed that the SMTC cycle is configured for an intra-V frequency carrier. If an SSB transmission cycle is greater than the SMTC cycle I configured for the intra-frequency carrier, an NR intra-frequency cell needs a longer detection cycle. [symbol]
indicates data missing or illegible when filed

It is worth noting that any element in Table 1 can be used alone or in combination with other elements in the table.

S122: in response to the UE having the first eDRX cycle and the first DRX cycle, determining the measurement configuration for RRM measurement according to the first eDRX cycle and the first DRX cycle.

It is worth noting that: S120 may include S121 alone, or include S122 alone, or contain S121 and S122 at the same time.

S122 has many specific implementing manners, when the UE has the first eDRX cycle, the measurement configuration is determined in combination with the first eDRX cycle and the first DRX cycle, and the determined measurement configuration includes but is not limited to: a measurement configuration for RRM measurement of a serving cell and/or a measurement configuration for RRM measurement of a neighboring cell. The neighboring cell includes but is not limited to: an intra-frequency neighboring cell and/or an inter-frequency neighboring cell and/or an inter-system neighboring cell. For example, the measurement configuration for RRM measurement may be determined according to any one of Table 2 to Table 7.

TABLE 2

| | | Duration of | | | |
|---|---|---|---|---|---|
| | | PTW [s] | | | Nserv |
| | Duration of | (number of | Scaling | | [number |
| Duration of | DRX cycle | durations | factor (N1) | | of DRX |
| eDRX cycle [s] | [s] | of 1.28 s) | FR1 | FR2 | cycles] |
| 2.56 ≤ length of | — | N/A | 1 | 3 | N1*2 |
| eDRX cycle ≤ | 0.32 | ≥1.28 (1) | | 8 | N1*2 |
| 2621.44 | 0.64 | ≥1.28 (1) | | 5 | N1*2 |
| | 1.28 | ≥2.56 (2) | | 4 | N1*2 |
| | 2.56 | ≥5.12 (4) | | 3 | N1*2 |

Note 1:
the DRX cycle involved in Nserv in the table is a DRX cycle in a PTW
Note 2:
if a duration of the eDRX cycle is 2.56 s or 5.12 s or 10.24 s, a value of the DRX cycle involved in Nserv is the duration of the corresponding eDRX cycle.

It is worth noting that any element in Table 2 can be used alone or in combination with other elements in the table.

TABLE 3

| | | Duration | | | | | |
|---|---|---|---|---|---|---|---|
| | | of PTW | | | | | |
| | | [s] | | | | | Evaluation |
| Duration | | (number | Scaling | | | Measurement | cycle [s] |
| of | Duration | of | factor | | | cycle [s] | (number of |
| eDRX | of DRX | durations | (N1) | | Detection cycle [s] (number of | (number of | DRX |
| cycle [s] | cycle [s] | of 1.28 s) | FR1 | FR2 | DRX cycles) | DRX cycles) | cycles) |
| 2.56 ≤ | — | N/A | 1 | 3 | | (1 × N1) | (2 × N1) |
| duration of eDRX | 0.32 | ≥1.28 (1) | | 8 | $eDRX\_cycle \_length \times [ \frac{23}{[ PTW / DRX\_cycle \_length ]} ]$ | 0.32 × N1 (1 × N1) | 0.64 × N1 (2 × N1) |
| cycle ≤ | 0.64 | ≥1.28 (1) | | 5 | × N1 (23 × N1) | 0.64 × N1 | 1.28 × N1 |
| 2621.44 | | | | | | (1 × N1) | (2 × N1) |
| | 1.28 | ≥2.56 (2) | | 4 | | 1.28 × N1 | 2.56 × N1 |
| | | | | | | (1 × N1) | (2 × N1) |
| | 2.56 | ≥5.12 (4) | | 3 | | 2.56× N1 | 5.12 × N1 |
| | | | | | | (1 × N1) | (2 × N1) |

Note 1:
supporting power classes 2, 3 and 4 to use values of N1 corresponding to FRI and FR2. UE supporting power class 1 uses N1 = 8
Note 2:
the DRX cycle involved in the table is a DRX cycle in a PTW
Note 3:
if a duration of the eDRX cycle is 2.56 s or 5.12 s or 10.24 s, a value of the DRX cycle involved in Nserv is the duration of the corresponding eDRX cycle.

It is worth noting that any element in Table 3 can be used alone or in combination with other elements in the table.

In one example, Table 2 and Table 3 may be used alone or in combination.

TABLE 4

| | | Duration of | | | |
|---|---|---|---|---|---|
| | | PTW [s] | | | Nserv |
| | Duration of | (number of | Scaling | | [number |
| Length of | DRX cycle | durations | factor (N1) | | of DRX |
| eDRX cycle [s] | [s] | of 1.28 s) | FR1 | FR2^{Note1} | cycles] |
| 2.56 ≤ length of | 0.32 | ≥1.28 (1) | 1 | 8 | M1*N1*4 |
| eDRX cycle ≤ | 0.64 | ≥1.28 (1) | | 5 | M1*N1*4 |
| 2621.44 | 1.28 | ≥2.56 (2) | | 4 | N1*2 |
| | 2.56 | ≥5.12 (4) | | 3 | N1*2 |

^{Note1}:
the DRX cycle involved in Nserv in the table is a DRX cycle in a PTW

It is worth noting that any element in Table 4 can be used alone or in combination with other elements in the table.

TABLE 5

| | | Duration | | | | | |
|---|---|---|---|---|---|---|---|
| | | of PTW | Detection | | | | |
| | | [s] | cycle [s] | | | | Duration of |
| Length | | (number | (number | | | Evaluation | idle |
| of | Duration | of | of DRX | | | cycle [s] | state |
| cycle | of DRX | durations | cycles) | | Measurement cycle [s] (number of | (number of | eDRX cycle |
| [s] | cycle [s] | of 1.28 s) | FR1 | FR2 | DRX cycles) | DRX cycles) | [s] |
| 2.56 ≤ length of | 0.32 | ≥1.28 (1) | 1 | 8 | $eDRX\_cycle \_length \times [ \frac{23}{[ PTW / DRX\_cycle \_length ]} ]$ | 0.32 × N1 (1 × N1) | 0.64 × N1 (2 × N1) |
| eDRX | 0.64 | ≥1.28 (1) | | 5 | ×N1 (23 × N1) | 0.64 × N1 | 1.28 × N1 |
| cycle ≤ | | | | | | (1 × N1) | (2 × N1) |
| 2621.44 | 1.28 | ≥2.56 (2) | | 4 | | 1.28 × N1 | 2.56 × N1 |
| | | | | | | (1 × N1) | (2 × N1) |
| | 2.56 | ≥5.12 (4) | | 3 | | 2.56× N1 | 5.12 × N1 |
| | | | | | | (1 × N1) | (2 × N1) |

Note 1:
supporting power classes 2, 3 and 4 to use values of N1 corresponding to FRI and FR2. UE supporting power class 1 uses N1 = 8
Note 2:
the DRX cycle involved in the table is a DRX cycle in a PTW

It is worth noting that any element in Table 5 can be used alone or in combination with other elements in the table.

In one example, Table 4 and Table 5 may be used alone or in combination.

TABLE 6

| | | Nserv |
|---|---|---|
| Duration | Scaling | [number |
| of DRX | factor (N1) | of DRX |

| cycle (s) | FR1 | FR2^{Note1} | cycles] |
|---|---|---|---|
| 0.32 | 1 | 8 | M1*N1*4 |
| 0.64 | | 5 | M1*N1*4 |
| 1.28 | | 4 | N1*2 |
| 2.56_{Note2} | | 3 | N1*2 |

^{Note1}:
supporting power classes 2, 3 and 4 to use values of N1 corresponding to FR1 and FR2. UE supporting power class 1 uses N1 = 8
^{Note2}:
the requirement that the DRX cycle in the table is 2.56 s is suitable for the situation that the eDRX cycle is 2.56 s

It is worth noting that any element in Table 6 can be used alone or in combination with other elements in the table.

TABLE 7

| | | | Detection | Measurement | Evaluation |
|---|---|---|---|---|---|
| Duration | Scaling | | cycle [s] | cycle [s] | cycle [s] |
| of DRX | factor (N1) | | (number of | (number of | (number of |
| cycle (s) | FR1 | FR2^{Note1} | DRX cycles) | DRX cycles) | DRX cycles) |
| 0.32 | 1 | 8 | 11.52 × N1 × M2 | 1.28 × N1 × M2 | 5.12 × N1 × M2 |
| | | | (36 × N1 × M2) | (4 × N1 × M2) | (16 × N1 × M2) |
| 0.64 | | 5 | 17.92 × N1 (28 × N1) | 1.28 × N1 (2 × N1) | 5.12 × N1 (8 × N1) |
| 1.28 | | 4 | 32 × N1 (25 × N1) | 1.28 × N1 (1 × N1) | 6.4 × N1 (5 × N1) |
| 2.56^{Note3} | | 3 | 58.88 × N1 (23 × N1) | 2.56 × N1 (1 × N1) | 7.68 × N1 (3 × N1) |

^{Note1}:
supporting power classes 2, 3 and 4 to use values of N1 corresponding to FR1 and FR2. UE supporting power class 1 uses N1 = 8
Note 2:
if an SMTC cycle used for measurement of an intra-frequency cell is greater than 20 ms, M2 = 1.5, otherwise, M2 = 1 if different cells are configured with different SMTC time periods. The SMTC cycle in this note is the one used by the cell being identified. During PSS/SSS detection, it is assumed that the SMTC cycle is configured for an intra-frequency carrier. If an SSB transmission cycle is greater than the SMTC cycle configured for the intra-frequency carrier, an NR intra-frequency cell needs a longer detection cycle.
Note 2:
the requirement that the DRX cycle in the table is 2.56 s is suitable for the situation that the eDRX cycle is 2.56 s

It is worth noting that any element in Table 7 can be used alone or in combination with other elements in the table.

In one example, Table 6 and Table 7 may be used alone or in combination.

The above-mentioned are merely examples in which the measurement configuration for RRM measurement is determined using Table 2 to Table 7 and is not limited to this during specific embodiment.

In some examples, S120 may further include: in response to the UE having the first eDRX cycle and the first DRX cycle and the UE has a first PTW, determining a measurement configuration for RRM measurement performed within the first PTW according to the first eDRX cycle, the first DRX cycle and the first PTW; or, in response to the UE having the first eDRX cycle and the first DRX cycle and the UE does not have the first PTW, determining a measurement configuration for RRM measurement performed within a time domain according to the first eDRX cycle and the first DRX cycle.

For example, the first PTW may be the PTW of the idle state eDRX cycle or the PTW of the inactive state eDRX cycle of the UE.

For another example, the first PTW is the PTW of the idle state eDRX cycle or the inactive state eDRX cycle which is equal to the first eDRX cycle.

In some examples, the measurement configuration for RRM measurement includes at least one of the following: a measurement cycle Nserv of RRM measurement for a serving cell of the UE; or a detection cycle, a measurement cycle and/or an evaluation cycle of RRM measurement for a neighboring cell of the UE.

An example of the disclosure provides a method for determining a measurement configuration for RRM measurement to define measurement requirements of a terminal under an eDRX configuration; and idle state UE is configured with an idle state eDRX cycle which is 2.56 s.

Case 1: if a base station does not support the idle state eDRX cycle to be 2.56 s and/or the terminal does not support the idle state eDRX cycle to be 2.56 s, or the terminal determines at this moment that: the UE is not configured with an eDRX cycle, then a DRX cycle at this moment is 2.56 s, measurement parameters during RRM measurement of the UE may be in the following way:

Nserv and other parameters will be determined according to the eDRX cycle or the DRX cycle or the like.

The UE may be in an idle state or an inactive state, and the measurement configuration for RRM measurement of the UE may be as shown in Table 1.

Case 2: if the base station has the capability of supporting the idle state eDRX cycle to be 2.56 s, the terminal also has the capability of supporting the idle state eDRX cycle to be 2.56 s and the terminal determines at this moment that: the UE is configured with eDRX cycle, then measurement parameters for RRM measurement are determined according to the following requirements, and several optional manners are provided below:

Manner 1: a requirement of omitting a PTW is added in an original eDRX table, and measurement is carried out according to a manner without a PTW.

Parameters for RRM measurement of a serving cell may be as shown in Table 2: a value of Nserv is one or more eDRX or DRX cycles, and as an example, each eDRX or DRX cycle is 2.56 s.

As an example, a measurement configuration for RRM measurement of a neighboring cell may be as follows, for example, referring to Table 3: the neighboring cell involved here includes but is not limited to: an intra-frequency neighboring cell and/or an inter-frequency neighboring cell.

A detection cycle, a measurement cycle and an evaluation cycle are determined according to the eDRX or DRX cycles.

The detection cycle will cross a plurality of DRX cycles, such as 23 DRX cycles; the measurement cycle is one or more eDRX cycles or DRX cycles; and the evaluation cycle is one or more eDRX cycles or DRX cycles.

Manner 2: measurement is carried out according to a manner with a PTW, that is, a duration of an eDRX cycle supported by the original table is directly extended to 2.56 s.

A measurement configuration for RRM measurement of a serving cell may be as shown in Table 4.

As an example, RRM measurement for a neighboring cell is as follows: the neighboring cell here includes: an intra-frequency neighboring cell and/or an inter-frequency neighboring cell.

A detection cycle is determined according to the eDRX cycle, and a measurement cycle and an evaluation cycle are determined according to a DRX cycle.

The detection cycle crosses a plurality of eDRX cycles; the measurement cycle is one or more eDRX cycles or DRX cycles; and the evaluation cycle is one or more eDRX cycles or DRX cycles. The measurement configuration may refer to Table 5.

Manner 3: the requirement of defining the eDRX cycle of 2.56 s is to directly reuse the DRX cycle of 2.56 s, which is added as a special case to a normal DRX requirement table. As an example, a measurement configuration for RRM measurement of a serving cell may refer to Table 6.

Measurement parameters for RRM measurement of a neighboring cell may be determined according to Table 7, and the neighboring cell here includes but is not limited to: an intra-frequency neighboring cell and/or an inter-frequency neighboring cell.

In one example, if inactive state UE is configured with an idle state eDRX cycle, the configured eDRX cycle is not greater than 10.24 s, and an inactive state eDRX cycle is not configured. Then, the idle state eDRX cycle is one of 10.24 s or 5.12 s or 2.56 s, the inactive state eDRX cycle is not configured, and at the moment, for the inactive state UE, several following optional manners are provided for determining measurement parameters for RRM measurement.

Optional manner 1: it is affirmed that the UE is not configured with an eDRX cycle; a DRX cycle=min{idle state eDRX cycle, RAN paging cycle}, and the measurement parameters for RRM measurement of the UE may be determined using the content as shown in Table 1.

Optional Manner 2: it is affirmed that the UE is configured with an eDRX cycle, the eDRX cycle is equal to the idle state eDRX cycle, and the measurement parameters for RRM measurement may be determined in the following way: if the eDRX cycle is 2.56 s at the moment, then RRM measurement may be carried out according to the regulation of 2.56 s in aforementioned case 2; and if the eDRX cycle is 5.12 s or 10.24 s at the moment, then RRM measurement may be carried out according to the measurement configuration for RRM measurement determined in any one of Table 2 to Table 5.

If the inactive state UE is configured with an idle state eDRX cycle and an inactive state eDRX cycle, and neither of the configured eDRX cycles is greater than 10.24 s. Then, if the idle state eDRX cycle is one of 10.24 s or 5.12 s or 2.56 s, and the inactive state eDRX cycle is equal to one of 10.24 s or 5.12 s or 2.56 s. Then at the moment the terminal determines that: the UE is configured with an eDRX cycle, and the eDRX cycle is min{idle state eDRX cycle, inactive state eDRX cycle} or the inactive state eDRX cycle. Parameters for RRM measurement may be determined in the following way: if the eDRX cycle is equal to 2.56 at the moment, then RRM measurement may be carried out according to the regulation of 2.56 s in the requirement of aforementioned case 2. If the eDRX cycle is equal to 5.12 or 10.24 at the moment, then RRM measurement may be carried out according to the measurement configuration for RRM measurement determined in any one of Table 2 to Table 5.

If the inactive state UE is configured with the idle state eDRX cycle which is greater than 10.24 s, then at the moment, the idle state eDRX cycle is configured with a PTW, the PTW is PTW1, and the inactive state is not configured with the inactive state eDRX cycle. Then the following manners may occur. Manner 1: time of RRM measurement is merely limited within a PTW (namely PTW1) of CN paging. Where it is determined that the UE is configured with an eDRX cycle; the eDRX cycle is the idle state eDRX cycle. For the idle state UE: a length of the DRX cycle=min{idle state DRX cycle, default paging cycle}. For the inactive state UE: a length of the DRX cycle=min{idle state DRX cycle, default paging cycle} or min{idle state DRX cycle, default paging cycle, RAN paging cycle}. Where a length of the PTW is the length of the idle state PTW, and the RRM measurement may be in accordance with the measurement configuration for RRM measurement determined in any one of Table 2 to Table 5.

Manner 2: the time of RRM measurement is not limited within the PTW of CN paging, and it is determined that: UE is not configured with eDRX cycle.

a DRX cycle=min{idle state eDRX cycle, RAN paging cycle}. The measurement parameters for RRM measurement may be determined using the content as shown in Table 1.

If the inactive state UE is configured with the idle state eDRX cycle which is greater than 10.24 s (at the moment, the idle state eDRX cycle is configured with PTW1) and the inactive state eDRX cycle is not greater than 10.24 s (at the moment, the inactive state eDRX cycle is provided, and an inactive state PTW is not provided), and at the moment, the terminal determines that: UE is configured with eDRX cycle, then one of the following manners occur.

Manner 1: the time of RRM measurement is merely limited within a PTW (namely PTW1) of CN paging. Where the eDRX cycle is equal to the idle state eDRX cycle. For the idle state UE: a length of the DRX cycle=min{idle state DRX cycle, default paging cycle}. For the inactive state UE: a length of the DRX cycle=min{idle state DRX cycle, default paging cycle} or min{idle state DRX cycle, default paging cycle, RAN paging cycle}. Where a length of the PTW is the length of the idle state PTW.

RRM measurement may be in accordance with the measurement configuration for RRM measurement determined in any one of Table 2 to Table 5.

Manner 2: the time of RRM measurement is not limited within the PTW of CN paging. The eDRX cycle=min {idle state eDRX cycle, inactive state eDRX cycle}. A length of the DRX cycle=min{idle state DRX cycle, default paging cycle} or min{idle state DRX cycle, default paging cycle, RAN paging cycle}. There is no PTW in actual measurement.

Requirements for RRM measurement: if the eDRX cycle is equal to 2.56 at the moment, then RRM measurement may be carried out according to the regulation of 2.56 s in the requirement of case 2; and if the eDRX cycle is equal to 5.12 or 10.24 at the moment, then RRM measurement may be carried out according to the measurement configuration for RRM measurement determined in any one of Table 2 to Table 5.

If the inactive state UE is configured with the idle state eDRX cycle which is greater than 10.24 s, at the moment, the PTW is PTW1 (PTW1 of CN paging), the inactive state eDRX cycle is greater than 10.24 s, at the moment, the PTW is PTW2 (PTW2 of RAN paging), and at the moment, the terminal determines that: UE is configured with eDRX cycle, then one of the following manner occurs.

Manner 1: the time of RRM measurement is merely limited within PTW1 of CN paging. Where the eDRX cycle is the idle state eDRX cycle. For the idle state UE: a length of the DRX cycle=min{idle state DRX cycle, default paging cycle}. For the inactive state UE: a length of the DRX cycle=min{idle state DRX cycle, default paging cycle} or min{idle state DRX cycle, default paging cycle, RAN paging cycle}. A length of the PTW is the length of the idle state PTW. The RRM measurement may be in accordance with the measurement configuration for RRM measurement determined in any one of Table 2 to Table 5.

Manner 2: the time of RRM measurement is merely limited within the PTW of RAN paging (for the inactive state UE only). Where the eDRX cycle is the inactive state eDRX cycle. A length of the DRX cycle=min{idle state DRX cycle, default paging cycle, RAN paging cycle} or min{default paging cycle, RAN paging cycle}, or the RAN paging cycle. Where a length of the PTW is the length of the inactive state PTW. The RRM measurement may be in accordance with the measurement configuration for RRM measurement determined in any one of Table 2 to Table 5.

Manner 3: for the inactive state UE only, the time of RRM measurement is not limited within the PTW of CN paging. Where the eDRX cycle=min{idle state eDRX cycle, inactive state eDRX cycle} or the inactive state eDRX cycle. A length of the DRX cycle=min{idle state DRX cycle, default paging cycle, RAN paging cycle}. A length of the PTW is min{idle state PTW, inactive state PTW}. The RRM measurement may be in accordance with the measurement configuration for RRM measurement determined in any one of Table 2 to Table 5.

An example of the disclosure provides an RRM measurement configuration determining method. The method may be executed by UE, and includes: the UE is in an idle state, an idle state eDRX cycle of the UE is configured as a first cycle and at least one of the UE and/or an anchor base station of the UE does not support the idle state eDRX cycle which is the first cycle, and it is determined that the UE does not have a first eDRX cycle, and a first DRX cycle is equal to the idle state eDRX cycle. A duration of the first cycle may be 2.56 s.

At the moment, a measurement configuration for RRM measurement of the UE is determined according to the first DRX cycle alone. For example, the measurement configuration for RRM measurement may be determined according to Table 1. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: the UE is in an inactive state, an inactive state eDRX cycle of the UE is configured as a first cycle and at least one of the UE and/or an anchor base station of the UE does not support the inactive state eDRX cycle which is the first cycle, and it is determined that the UE does not have a first eDRX cycle, and a first DRX cycle is equal to the inactive state eDRX cycle. A duration of the first cycle may be 2.56 s.

At the moment, a measurement configuration for RRM measurement of the UE is determined according to the first DRX cycle alone. For example, the measurement configuration for RRM measurement may be determined according to Table 1. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is in an inactive state, an idle state eDRX cycle of the UE is not greater than a second cycle, and an inactive state eDRX cycle of the UE is not configured, it is determined that the UE does not have a first eDRX cycle, and a first DRX cycle is determined according to an idle state eDRX configuration of the UE.

In the example of the disclosure, the first DRX cycle may be an idle state DRX cycle defined by the idle state eDRX configuration, or, the first DRX cycle is equal to a smaller one of the idle state eDRX cycle and an RAN paging cycle.

At the moment, a measurement configuration for RRM measurement of the UE is determined according to the first DRX cycle alone. For example, the measurement configuration for RRM measurement may be determined according to Table 1. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, then the UE is in an idle state, an idle state eDRX cycle of the UE is not greater than a second cycle, and an inactive state eDRX cycle of the UE is not configured, it is determined that the UE has a first eDRX cycle which is equal to the idle state eDRX cycle, and a first DRX cycle is determined according to an idle state eDRX configuration of the UE.

At the moment, a measurement configuration for RRM measurement of the UE is determined according to the first eDRX cycle and the first DRX cycle, for example, the measurement configuration for RRM measurement may be determined according to Table 2 and Table 3. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

In some cases, the first DRX cycle may be equal to the idle state eDRX cycle, or equal to any one of the first cycle to a third cycle. The first cycle may be an eDRX cycle with a duration of 2.56 s, the second cycle may be an eDRX cycle with a duration of 10.24 s, and the third cycle may be an eDRX cycle with a duration of 5.12 s.

An example of the disclosure provides an RRM measurement configuration determining method. The method may be executed by UE, and includes: in the method, if the UE and an anchor base station of the UE both support an eDRX cycle which is a first cycle, then the UE is in an idle state, an idle state eDRX cycle of the UE is not greater than a second cycle, and an inactive state eDRX cycle of the UE is not configured, it is determined that the UE has a first eDRX cycle which is equal to the idle state eDRX cycle, and a first DRX cycle is determined according to an idle state eDRX configuration of the UE.

At the moment, a measurement configuration for RRM measurement of the UE is determined according to the first eDRX cycle and the first DRX cycle, for example, the measurement configuration for RRM measurement may be determined according to Table 4 and Table 5. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

In some cases, the first DRX cycle may be equal to the idle state eDRX cycle, or equal to any one of the first cycle to a third cycle. The first cycle may be an eDRX cycle with a duration of 2.56 s, the second cycle may be an eDRX cycle with a duration of 10.24 s, and the third cycle may be an eDRX cycle with a duration of 5.12 s.

An example of the disclosure provides an RRM measurement configuration determining method. The method may be executed by UE, and includes: in the method, if the UE and an anchor base station of the UE both support an eDRX cycle which is a first cycle, then the UE is in an idle state, an idle state eDRX cycle of the UE is not greater than a second cycle, and an inactive state eDRX cycle of the UE is not configured, it is determined that the UE has a first eDRX cycle which is equal to the idle state eDRX cycle, and a first DRX cycle is determined according to an idle state eDRX configuration of the UE.

At the moment, a measurement configuration for RRM measurement of the UE is determined according to the first eDRX cycle and the first DRX cycle, for example, the measurement configuration for RRM measurement may be determined according to Table 6 and Table 7. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

In some cases, the first DRX cycle may be equal to the idle state eDRX cycle, or equal to any one of the first cycle to a third cycle. The first cycle may be an eDRX cycle with a duration of 2.56 s, the second cycle may be an eDRX cycle with a duration of 10.24 s, and the third cycle may be an eDRX cycle with a duration of 5.12 s.

An example of the disclosure provides an RRM measurement configuration determining method. The method may be executed by UE, and includes: in the method, if the UE and an anchor base station of the UE both support an eDRX cycle which is a first cycle, and if the UE is configured with an idle state eDRX cycle and an inactive state eDRX cycle, and both the idle state eDRX cycle and the inactive state eDRX cycle are not greater than a second cycle, it is determined that the UE has a first eDRX cycle which is equal to the inactive state eDRX cycle, and the UE has a DRX cycle which is equal to any one of the first cycle to a third cycle.

At the moment, a measurement configuration for RRM measurement of the UE is determined according to the first eDRX cycle and the first DRX cycle, for example, the measurement configuration for RRM measurement may be determined according to Table 2 and Table 3. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

In the method, if the UE and an anchor base station of the UE both support an eDRX cycle which is a first cycle, and if the UE is configured with an idle state eDRX cycle and an inactive state eDRX cycle, and both the idle state eDRX cycle and the inactive state eDRX cycle are not greater than a second cycle, it is determined that the UE has a first eDRX cycle which is equal to the inactive state eDRX cycle, and the UE has a DRX cycle which is equal to any one of the first cycle to a third cycle.

At the moment, a measurement configuration for RRM measurement of the UE is determined according to the first eDRX cycle and the first DRX cycle, for example, the measurement configuration for RRM measurement may be determined according to Table 4 and Table 5. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

In the method, if the UE and an anchor base station of the UE both support an eDRX cycle which is a first cycle, and if the UE is configured with an idle state eDRX cycle and an inactive state eDRX cycle, and both the idle state eDRX cycle and the inactive state eDRX cycle are not greater than a second cycle, it is determined that the UE has a first eDRX cycle which is equal to the inactive state eDRX cycle, and the UE has a DRX cycle which is equal to any one of the first cycle to a third cycle.

At the moment, a measurement configuration for RRM measurement of the UE is determined according to the first eDRX cycle and the first DRX cycle, for example, the measurement configuration for RRM measurement may be determined according to Table 6 and Table 7. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is configured with an idle state eDRX cycle and an inactive state eDRX cycle, and both the idle state eDRX cycle and the inactive state eDRX cycle are not greater than a second cycle, it is determined that the UE has a first eDRX cycle which is equal to a smaller one of the inactive state eDRX cycle and the idle state eDRX cycle, and the UE has a DRX cycle which is equal to any one of the first cycle to a third cycle.

At the moment, a measurement configuration for RRM measurement of the UE is determined according to the first eDRX cycle and the first DRX cycle, for example, the measurement configuration for RRM measurement may be determined according to Table 2 and Table 3. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is configured with an idle state eDRX cycle and an inactive state eDRX cycle, and both the idle state eDRX cycle and the inactive state eDRX cycle are not greater than a second cycle, it is determined that the UE has a first eDRX cycle which is equal to a smaller one of the inactive state eDRX cycle and the idle state eDRX cycle, and the UE has a DRX cycle which is equal to any one of the first cycle to a third cycle.

At the moment, a measurement configuration for RRM measurement of the UE is determined according to the first eDRX cycle and the first DRX cycle, for example, the measurement configuration for RRM measurement may be determined according to Table 4 and Table 5. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is configured with an idle state eDRX cycle and an inactive state eDRX cycle, and both the idle state eDRX cycle and the inactive state eDRX cycle are not greater than a second cycle, it is determined that the UE has a first eDRX cycle which is equal to a smaller one of the inactive state eDRX cycle and the idle state eDRX cycle, and the UE has a DRX cycle which is equal to any one of the first cycle to a third cycle.

At the moment, a measurement configuration for RRM measurement of the UE is determined according to the first eDRX cycle and the first DRX cycle, for example, the measurement configuration for RRM measurement may be determined according to Table 6 and Table 7. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is in an idle state, an idle state eDRX cycle of the UE is greater than a second cycle, and an inactive state eDRX cycle is not configured, it may be determined that the UE does not have a first eDRX cycle, and the UE has a first DRX cycle.

The first DRX cycle of the UE may be equal to the idle state eDRX cycle or an RAN paging cycle; or, the first DRX cycle of the UE is equal to a smaller one of the idle state eDRX cycle and the RAN paging cycle.

In this case, a measurement configuration for RRM measurement of the UE may be determined according to the first DRX cycle of the UE alone. For example, the measurement configuration for RRM measurement of the UE may be determined referring to Table 1. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is in an idle state, an idle state eDRX cycle of the UE is greater than a second cycle, and an inactive state eDRX cycle is not configured, it may be determined that the UE has a first eDRX cycle which is equal to the idle state eDRX cycle, and the UE has a first DRX cycle.

The first DRX cycle of the UE may be at least one of the following: the first DRX cycle being equal to the idle state eDRX cycle; the first DRX cycle being equal to an RAN paging cycle; the first DRX cycle being equal to a smaller one of the idle state eDRX cycle and the RAN paging cycle; or a smallest one of an idle state DRX cycle defined by an idle state eDRX configuration, an RAN paging cycle defined by an inactive state eDRX configuration and a default paging cycle.

At the moment, a measurement configuration for RRM measurement of the UE is determined according to the first eDRX cycle and the first DRX cycle, for example, the measurement configuration for RRM measurement may be determined according to Table 2 and Table 3. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

If the idle state eDRX cycle of the UE is greater than the second cycle, then the idle state eDRX cycle of the UE has a PTW, and if the idle state eDRX cycle is configured as the first eDRX cycle, then measurement time of RRM measurement may be limited within the PTW of the idle state eDRX cycle.

An example of the disclosure provides an RRM measurement configuration determining method. The method may be executed by UE, and includes: in the method, if the UE and an anchor base station of the UE both support an eDRX cycle which is a first cycle, and if the UE is in an idle state, an idle state eDRX cycle of the UE is greater than a second cycle, and an inactive state eDRX cycle is not configured, it may be determined that the UE has a first eDRX cycle which is equal to the idle state eDRX cycle, and the UE has a first DRX cycle.

The first DRX cycle of the UE may be at least one of the following: the first DRX cycle being equal to the idle state eDRX cycle; the first DRX cycle being equal to an RAN paging cycle; the first DRX cycle being equal to a smaller one of the idle state eDRX cycle and the RAN paging cycle; or a smallest one of an idle state DRX cycle defined by an idle state eDRX configuration, an RAN paging cycle defined by an inactive state eDRX configuration and a default paging cycle.

At the moment, a measurement configuration for RRM measurement of the UE is determined according to the first eDRX cycle and the first DRX cycle, for example, the measurement configuration for RRM measurement may be determined according to Table 4 and Table 5. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

If the idle state eDRX cycle of the UE is greater than the second cycle, then the idle state eDRX cycle of the UE has a PTW, and if the idle state eDRX cycle is configured as the first eDRX cycle, then measurement time of RRM measurement may be limited within the PTW of the idle state eDRX cycle.

An example of the disclosure provides an RRM measurement configuration determining method. The method may be executed by UE, and includes: in the method, if the UE and an anchor base station of the UE both support an eDRX cycle which is a first cycle, and if the UE is in an idle state, an idle state eDRX cycle of the UE is greater than a second cycle, and an inactive state eDRX cycle is not configured, it may be determined that the UE has a first eDRX cycle which is equal to the idle state eDRX cycle, and the UE has a first DRX cycle.

The first DRX cycle of the UE may be at least one of the following: the first DRX cycle being equal to the idle state eDRX cycle; the first DRX cycle being equal to an RAN paging cycle; the first DRX cycle being equal to a smaller one of the idle state eDRX cycle and the RAN paging cycle; or a smallest one of an idle state DRX cycle defined by an idle state eDRX configuration, an RAN paging cycle defined by an inactive state eDRX configuration and a default paging cycle.

At the moment, a measurement configuration for RRM measurement of the UE is determined according to the first eDRX cycle and the first DRX cycle, for example, the measurement configuration for RRM measurement may be determined according to Table 6 and Table 7. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

If the idle state eDRX cycle of the UE is greater than the second cycle, then the idle state eDRX cycle of the UE has a PTW, and if the idle state eDRX cycle is configured as the first eDRX cycle, then measurement time of RRM measurement may be limited within the PTW of the idle state eDRX cycle.

An example of the disclosure provides an RRM measurement configuration determining method. The method may be executed by UE, and includes: in the method, if the UE and an anchor base station of the UE both support an eDRX cycle which is a first cycle, and if the UE is in an inactive state, an idle state eDRX cycle of the UE is greater than a second cycle, and an inactive state eDRX cycle is not configured, it is determined that the UE has a first eDRX cycle which is equal to the idle state eDRX cycle, and a first DRX cycle may be determined according to an idle state eDRX cycle configuration.

For example, the first DRX cycle may be at least one of the following: the first DRX cycle being a smaller one of an idle state DRX cycle defined by the idle state eDRX configuration and a default paging cycle; or the first DRX cycle being the idle state DRX cycle defined by the idle state eDRX configuration.

The first DRX cycle may further be: a smallest one of the idle state DRX cycle defined by the idle state eDRX configuration, a RAN paging cycle defined by an inactive state eDRX configuration, and the default paging cycle.

If the idle state eDRX cycle of the UE is greater than the second cycle, then the idle state eDRX cycle of the UE has a PTW, and if the idle state eDRX cycle is configured as the first eDRX cycle, then measurement time of RRM measurement may be limited within the PTW of the idle state eDRX cycle.

At the moment, a measurement configuration for RRM measurement of the UE is determined according to the first eDRX cycle and the first DRX cycle, for example, the measurement configuration for RRM measurement may be determined according to Table 6 and Table 7. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

At the moment, the measurement configuration for RRM measurement of the UE is determined in combination with the first eDRX cycle and the first DRX cycle of the UE.

For example, the measurement configuration for RRM measurement may be determined according to Table 2 and Table 3. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is in an inactive state, an idle state eDRX cycle of the UE is greater than a second cycle, and an inactive state eDRX cycle is not configured, it is determined that the UE has a first eDRX cycle which is equal to the idle state eDRX cycle, and a first DRX cycle may be determined according to an idle state eDRX cycle configuration.

For example, the first DRX cycle may be at least one of the following: the first DRX cycle being a smaller one of an idle state DRX cycle defined by the idle state eDRX configuration and a default paging cycle; or the first DRX cycle being the idle state DRX cycle defined by the idle state eDRX configuration.

The first DRX cycle may further be: a smallest one of the idle state DRX cycle defined by the idle state eDRX configuration, a RAN paging cycle defined by an inactive state eDRX configuration, and the default paging cycle.

If the idle state eDRX cycle of the UE is greater than the second cycle, then the idle state eDRX cycle of the UE has a PTW, and if the idle state eDRX cycle is configured as the first eDRX cycle, then measurement time of RRM measurement may be limited within the PTW of the idle state eDRX cycle.

At the moment, a measurement configuration for RRM measurement of the UE is determined according to the first eDRX cycle and the first DRX cycle, for example, the measurement configuration for RRM measurement may be determined according to Table 6 and Table 7. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

At the moment, the measurement configuration for RRM measurement of the UE is determined in combination with the first eDRX cycle and the first DRX cycle of the UE.

For example, the measurement configuration for RRM measurement may be determined according to Table 4 and Table 5. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is in an inactive state, an idle state eDRX cycle of the UE is greater than a second cycle, and an inactive state eDRX cycle is not configured, it is determined that the UE has a first eDRX cycle which is equal to the idle state eDRX cycle, and a first DRX cycle may be determined according to an idle state eDRX cycle configuration.

For example, the first DRX cycle may be at least one of the following: the first DRX cycle being a smaller one of an idle state DRX cycle defined by the idle state eDRX configuration and a default paging cycle; or the first DRX cycle being the idle state DRX cycle defined by the idle state eDRX configuration.

The first DRX cycle may further be: a smallest one of the idle state DRX cycle defined by the idle state eDRX configuration, a RAN paging cycle defined by an inactive state eDRX configuration, and the default paging cycle.

If the idle state eDRX cycle of the UE is greater than the second cycle, then the idle state eDRX cycle of the UE has a PTW, and if the idle state eDRX cycle is configured as the first eDRX cycle, then measurement time of RRM measurement may be limited within the PTW of the idle state eDRX cycle.

At the moment, a measurement configuration for RRM measurement of the UE is determined according to the first eDRX cycle and the first DRX cycle, for example, the measurement configuration for RRM measurement may be determined according to Table 6 and Table 7. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

At the moment, the measurement configuration for RRM measurement of the UE is determined in combination with the first eDRX cycle and the first DRX cycle of the UE.

For example, the measurement configuration for RRM measurement may be determined according to Table 6 and Table 7. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is in an idle state, an idle state eDRX cycle of the UE is greater than a second cycle, and an inactive state eDRX cycle not greater than the second cycle is configured, it may be determined that the UE has a first eDRX cycle which is equal to the idle state eDRX cycle.

As the current idle state eDRX cycle is greater than the second cycle, measurement time of RRM measurement may be located within a PTW of the eDRX cycle.

At the moment, a first DRX cycle of the UE may be at least one of the following: a DRX cycle defined by an idle state eDRX configuration; or the first DRX cycle being a smaller one of an eDRX cycle defined by the idle state eDRX configuration and a default paging cycle.

At the moment, a measurement configuration for RRM measurement of the UE is determined in combination with the first eDRX cycle and the first DRX cycle of the UE.

For example, the measurement configuration for RRM measurement may be determined according to Table 2 and Table 3. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is in an idle state, an idle state eDRX cycle of the UE is greater than a second cycle, and an inactive state eDRX cycle not greater than the second cycle is configured, it may be determined that the UE has a first eDRX cycle which is equal to the idle state eDRX cycle.

As the current idle state eDRX cycle is greater than the second cycle, measurement time of RRM measurement may be located within a PTW of the eDRX cycle.

At the moment, a first DRX cycle of the UE may be at least one of the following: a DRX cycle defined by an idle state eDRX configuration; or the first DRX cycle being a smaller one of an eDRX cycle defined by the idle state eDRX configuration and a default paging cycle.

At the moment, a measurement configuration for RRM measurement of the UE is determined in combination with the first eDRX cycle and the first DRX cycle of the UE.

For example, the measurement configuration for RRM measurement may be determined according to Table 4 and Table 5. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is in an idle state, an idle state eDRX cycle of the UE is greater than a second cycle, and an inactive state eDRX cycle not greater than the second cycle is configured, it may be determined that the UE has a first eDRX cycle which is equal to the idle state eDRX cycle.

As the current idle state eDRX cycle is greater than the second cycle, measurement time of RRM measurement may be located within a PTW of the eDRX cycle.

At the moment, a first DRX cycle of the UE may be at least one of the following: a DRX cycle defined by an idle state eDRX configuration; or the first DRX cycle being a smaller one of an eDRX cycle defined by the idle state eDRX configuration and a default paging cycle.

At the moment, a measurement configuration for RRM measurement of the UE is determined in combination with the first eDRX cycle and the first DRX cycle of the UE.

For example, the measurement configuration for RRM measurement may be determined according to Table 6 and Table 7. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is in an inactive state, an idle state eDRX cycle of the UE is greater than a second cycle, and an inactive state eDRX cycle not greater than the second cycle is configured, it is determined that the UE has a first eDRX cycle and a first DRX cycle.

The first eDRX cycle of the UE is equal to the idle state eDRX cycle.

If the first eDRX cycle is equal to the idle state eDRX cycle, then the first DRX cycle of the UE may be one of the following: the first DRX cycle being an idle state DRX cycle defined by an idle state eDRX configuration; or the first DRX cycle being a smaller one of the idle state DRX cycle defined by the idle state eDRX configuration and a default paging cycle.

As the UE has the first eDRX cycle and the first DRX cycle at the same time, a measurement configuration for RRM measurement of the UE will be determined in combination with the first eDRX cycle and the first DRX cycle.

For example, the measurement configuration for RRM measurement may be determined according to Table 2 and Table 3. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is in an inactive state, an idle state eDRX cycle of the UE is greater than a second cycle, and an inactive state eDRX cycle not greater than the second cycle is configured, it is determined that the UE has a first eDRX cycle and a first DRX cycle.

The first eDRX cycle of the UE is equal to the idle state eDRX cycle.

If the first eDRX cycle is equal to the idle state eDRX cycle, then the first DRX cycle of the UE may be one of the following: the first DRX cycle being an idle state DRX cycle defined by an idle state eDRX configuration; or the first DRX cycle being a smaller one of the idle state DRX cycle defined by the idle state eDRX configuration and a default paging cycle.

As the UE has the first eDRX cycle and the first DRX cycle at the same time, a measurement configuration for RRM measurement of the UE will be determined in combination with the first eDRX cycle and the first DRX cycle.

For example, the measurement configuration for RRM measurement may be determined according to Table 4 and Table 5. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes:
in the method, if the UE and an anchor base station of the UE both support an eDRX cycle which is a first cycle, and if the UE is in an inactive state, an idle state eDRX cycle of the UE is greater than a second cycle, and an inactive state eDRX cycle not greater than the second cycle is configured, it is determined that the UE has a first eDRX cycle and a first DRX cycle.

The first eDRX cycle of the UE is equal to the idle state eDRX cycle.

If the first eDRX cycle is equal to the idle state eDRX cycle, then the first DRX cycle of the UE may be one of the following: the first DRX cycle being an idle state DRX cycle defined by an idle state eDRX configuration; or the first DRX cycle being a smaller one of the idle state DRX cycle defined by the idle state eDRX configuration and a default paging cycle.

As the UE has the first eDRX cycle and the first DRX cycle at the same time, a measurement configuration for RRM measurement of the UE will be determined in combination with the first eDRX cycle and the first DRX cycle.

For example, the measurement configuration for RRM measurement may be determined according to Table 6 and Table 7. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is in an inactive state, an idle state eDRX cycle of the UE is greater than a second cycle, and an inactive state eDRX cycle not greater than the second cycle is configured, it is determined that the UE has a first eDRX cycle and a first DRX cycle.

The first eDRX cycle of the UE is equal to a smaller one of the idle state eDRX cycle and the inactive state eDRX cycle.

The first DRX cycle of the UE may be one of the following: the first DRX cycle being a smaller one of an idle state DRX cycle defined by an idle state eDRX configuration and a default paging cycle; the first DRX cycle being a smallest one of the idle state DRX cycle defined by the idle state eDRX configuration, an RAN paging cycle defined by an inactive state eDRX configuration, and the default paging cycle; or the first DRX cycle being a smaller one of the idle state DRX cycle defined by the idle state eDRX configuration and the RAN paging cycle defined by the inactive state eDRX configuration.

As the UE has the first eDRX cycle and the first DRX cycle at the same time, a measurement configuration for RRM measurement of the UE will be determined in combination with the first eDRX cycle and the first DRX cycle.

For example, the measurement configuration for RRM measurement may be determined according to Table 2 and Table 3. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is in an inactive state, an idle state eDRX cycle of the UE is greater than a second cycle, and an inactive state eDRX cycle not greater than the second cycle is configured, it is determined that the UE has a first eDRX cycle and a first DRX cycle.

The first eDRX cycle of the UE is equal to a smaller one of the idle state eDRX cycle and the inactive state eDRX cycle.

The first DRX cycle of the UE may be one of the following: the first DRX cycle being a smaller one of an idle state DRX cycle defined by an idle state eDRX configuration and a default paging cycle; the first DRX cycle being a smallest one of the idle state DRX cycle defined by the idle state eDRX configuration, an RAN paging cycle defined by an inactive state eDRX configuration, and the default paging cycle; or the first DRX cycle being a smaller one of the idle state DRX cycle defined by the idle state eDRX configuration and the RAN paging cycle defined by the inactive state eDRX configuration.

As the UE has the first eDRX cycle and the first DRX cycle at the same time, a measurement configuration for RRM measurement of the UE will be determined in combination with the first eDRX cycle and the first DRX cycle.

For example, the measurement configuration for RRM measurement may be determined according to Table 4 and Table 5. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is in an inactive state, an idle state eDRX cycle of the UE is greater than a second cycle, and an inactive state eDRX cycle not greater than the second cycle is configured, it is determined that the UE has a first eDRX cycle and a first DRX cycle.

The first eDRX cycle of the UE is equal to a smaller one of the idle state eDRX cycle and the inactive state eDRX cycle.

The first DRX cycle of the UE may be one of the following: the first DRX cycle being a smaller one of an idle state DRX cycle defined by an idle state eDRX configuration and a default paging cycle; the first DRX cycle being a smallest one of the idle state DRX cycle defined by the idle state eDRX configuration, an RAN paging cycle defined by an inactive state eDRX configuration, and the default paging cycle; or the first DRX cycle being a smaller one of the idle state DRX cycle defined by the idle state eDRX configuration and the RAN paging cycle defined by the inactive state eDRX configuration.

As the UE has the first eDRX cycle and the first DRX cycle at the same time, a measurement configuration for RRM measurement of the UE will be determined in combination with the first eDRX cycle and the first DRX cycle.

For example, the measurement configuration for RRM measurement may be determined according to Table 6 and Table 7. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is in an inactive state, an idle state eDRX cycle of the UE is greater than a second cycle, and an inactive state eDRX cycle greater than the second cycle is configured, it is determined that the UE has a first eDRX cycle and a first DRX cycle.

The first eDRX cycle of the UE may be: the idle state eDRX cycle; the first DRX cycle of the UE may be: an idle state DRX cycle defined by an idle state eDRX configuration; a smaller one of an RAN paging cycle defined by an inactive state eDRX configuration and a default paging cycle; or a smallest one of the idle state DRX cycle defined by the idle state eDRX configuration, the RAN paging cycle defined by the inactive state eDRX configuration and the default paging cycle.

If the first eDRX cycle is equal to the idle state eDRX cycle, then measurement time of RRM measurement of the UE is located within a PTW of the idle state eDRX cycle. If the first eDRX cycle is equal to the inactive state eDRX cycle, then the measurement time of RRM measurement of the UE is located within a PTW of the inactive state eDRX cycle.

As the UE has the first eDRX cycle and the first DRX cycle at the same time, a measurement configuration for RRM measurement of the UE will be determined in combination with the first eDRX cycle and the first DRX cycle.

For example, the measurement configuration for RRM measurement may be determined according to Table 2 and Table 3. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is in an inactive state, an idle state eDRX cycle of the UE is greater than a second cycle, and an inactive state eDRX cycle greater than the second cycle is configured, it is determined that the UE has a first eDRX cycle and a first DRX cycle.

The first eDRX cycle of the UE may be: the idle state eDRX cycle; the first DRX cycle of the UE may be: an idle state DRX cycle defined by an idle state eDRX configuration; a smaller one of an RAN paging cycle defined by an inactive state eDRX configuration and a default paging cycle; or a smallest one of the idle state DRX cycle defined by the idle state eDRX configuration, the RAN paging cycle defined by the inactive state eDRX configuration and the default paging cycle.

If the first eDRX cycle is equal to the idle state eDRX cycle, then measurement time of RRM measurement of the UE is located within a PTW of the idle state eDRX cycle. If the first eDRX cycle is equal to the inactive state eDRX cycle, then the measurement time of RRM measurement of the UE is located within a PTW of the inactive state eDRX cycle.

As the UE has the first eDRX cycle and the first DRX cycle at the same time, a measurement configuration for RRM measurement of the UE will be determined in combination with the first eDRX cycle and the first DRX cycle.

For example, the measurement configuration for RRM measurement may be determined according to Table 4 and Table 5. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is in an inactive state, an idle state eDRX cycle of the UE is greater than a second cycle, and an inactive state eDRX cycle greater than the second cycle is configured, it is determined that the UE has a first eDRX cycle and a first DRX cycle.

The first eDRX cycle of the UE may be: the idle state eDRX cycle; the first DRX cycle of the UE may be: an idle state DRX cycle defined by an idle state eDRX configuration; a smaller one of an RAN paging cycle defined by an inactive state eDRX configuration and a default paging cycle; or a smallest one of the idle state DRX cycle defined by the idle state eDRX configuration, the RAN paging cycle defined by the inactive state eDRX configuration and the default paging cycle.

If the first eDRX cycle is equal to the idle state eDRX cycle, then measurement time of RRM measurement of the UE is located within a PTW of the idle state eDRX cycle. If the first eDRX cycle is equal to the inactive state eDRX cycle, then the measurement time of RRM measurement of the UE is located within a PTW of the inactive state eDRX cycle.

As the UE has the first eDRX cycle and the first DRX cycle at the same time, a measurement configuration for RRM measurement of the UE will be determined in combination with the first eDRX cycle and the first DRX cycle.

For example, the measurement configuration for RRM measurement may be determined according to Table 6 and Table 7. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is in an inactive state, an idle state eDRX cycle of the UE is greater than a second cycle, and an inactive state eDRX cycle greater than the second cycle is configured, it is determined that the UE has a first eDRX cycle and a first DRX cycle.

The first eDRX cycle of the UE is the inactive state eDRX cycle.

If the UE has the first eDRX cycle which is equal to the inactive state eDRX cycle, then the first DRX cycle of the UE may be as follows: an RAN paging cycle defined by an inactive state eDRX configuration; a smallest one of an idle state DRX cycle defined by an idle state eDRX configuration, a default paging cycle and the RAN paging cycle defined by the inactive state eDRX configuration; or a smaller one of the default paging cycle and the RAN paging cycle defined by the inactive state eDRX configuration.

As the UE has the first eDRX cycle and the first DRX cycle at the same time, a measurement configuration for RRM measurement of the UE will be determined in combination with the first eDRX cycle and the first DRX cycle.

For example, the measurement configuration for RRM measurement may be determined according to Table 2 and Table 3. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is in an inactive state, an idle state eDRX cycle of the UE is greater than a second cycle, and an inactive state eDRX cycle greater than the second cycle is configured, it is determined that the UE has a first eDRX cycle and a first DRX cycle.

The first eDRX cycle of the UE is the inactive state eDRX cycle.

If the UE has the first eDRX cycle which is equal to the inactive state eDRX cycle, then the first DRX cycle of the UE may be as follows: an RAN paging cycle defined by an inactive state eDRX configuration; a smallest one of an idle state DRX cycle defined by an idle state eDRX configuration, a default paging cycle and the RAN paging cycle defined by the inactive state eDRX configuration; or a smaller one of the default paging cycle and the RAN paging cycle defined by the inactive state eDRX configuration.

As the UE has the first eDRX cycle and the first DRX cycle at the same time, a measurement configuration for RRM measurement of the UE will be determined in combination with the first eDRX cycle and the first DRX cycle.

For example, the measurement configuration for RRM measurement may be determined according to Table 4 and Table 5. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is in an inactive state, an idle state eDRX cycle of the UE is greater than a second cycle, and an inactive state eDRX cycle greater than the second cycle is configured, it is determined that the UE has a first eDRX cycle and a first DRX cycle.

The first eDRX cycle of the UE is the inactive state eDRX cycle.

If the UE has the first eDRX cycle which is equal to the inactive state eDRX cycle, then the first DRX cycle of the UE may be as follows: an RAN paging cycle defined by an inactive state eDRX configuration; a smallest one of an idle state DRX cycle defined by an idle state eDRX configuration, a default paging cycle and the RAN paging cycle defined by the inactive state eDRX configuration; or a smaller one of the default paging cycle and the RAN paging cycle defined by the inactive state eDRX configuration.

As the UE has the first eDRX cycle and the first DRX cycle at the same time, a measurement configuration for RRM measurement of the UE will be determined in combination with the first eDRX cycle and the first DRX cycle.

For example, the measurement configuration for RRM measurement may be determined according to Table 6 and Table 7. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is in an inactive state, an idle state eDRX cycle of the UE is greater than a second cycle, and an inactive state eDRX cycle greater than the second cycle is configured, it is determined that the UE has a first eDRX cycle and a first DRX cycle.

The first eDRX cycle of the UE is equal to a smaller one of the idle state eDRX cycle and the inactive state eDRX cycle.

The first DRX cycle of the UE is one of the following: the first DRX cycle being a smallest one of an idle state DRX cycle defined by an idle state eDRX configuration, a default paging cycle and an RAN paging cycle defined by an inactive state eDRX configuration; the first DRX cycle being a smaller one of the default paging cycle and the RAN paging cycle defined by the inactive state eDRX configuration; or the first DRX cycle being a smaller one of the default paging cycle and the idle state DRX cycle defined by the idle state eDRX configuration.

As the UE has the first eDRX cycle and the first DRX cycle at the same time, a measurement configuration for RRM measurement of the UE will be determined in combination with the first eDRX cycle and the first DRX cycle.

For example, the measurement configuration for RRM measurement may be determined according to Table 2 and Table 3. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is in an inactive state, an idle state eDRX cycle of the UE is greater than a second cycle, and an inactive state eDRX cycle greater than the second cycle is configured, it is determined that the UE has a first eDRX cycle and a first DRX cycle.

The first eDRX cycle of the UE is equal to a smaller one of the idle state eDRX cycle and the inactive state eDRX cycle.

The first DRX cycle of the UE is one of the following: the first DRX cycle being a smallest one of an idle state DRX cycle defined by an idle state eDRX configuration, a default paging cycle and an RAN paging cycle defined by an inactive state eDRX configuration; the first DRX cycle being a smaller one of the default paging cycle and the RAN paging cycle defined by the inactive state eDRX configuration; or the first DRX cycle being a smaller one of the default paging cycle and the idle state DRX cycle defined by the idle state eDRX configuration.

As the UE has the first eDRX cycle and the first DRX cycle at the same time, a measurement configuration for RRM measurement of the UE will be determined in combination with the first eDRX cycle and the first DRX cycle.

For example, the measurement configuration for RRM measurement may be determined according to Table 4 and Table 5. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

An example of the disclosure provides an RRM measurement configuration determining method. The method may be executed by UE, and includes: in the method, if the UE and an anchor base station of the UE both support an eDRX cycle which is a first cycle, and if the UE is in an inactive state, an idle state eDRX cycle of the UE is greater than a second cycle, and an inactive state eDRX cycle greater than the second cycle is configured, it is determined that the UE has a first eDRX cycle and a first DRX cycle.

The first eDRX cycle of the UE is equal to a smaller one of the idle state eDRX cycle and the inactive state eDRX cycle.

The first DRX cycle of the UE is one of the following: the first DRX cycle being a smallest one of an idle state DRX cycle defined by an idle state eDRX configuration, a default paging cycle and an RAN paging cycle defined by an inactive state eDRX configuration; the first DRX cycle being a smaller one of the default paging cycle and the RAN paging cycle defined by the inactive state eDRX configuration; or the first DRX cycle being a smaller one of the default paging cycle and the idle state DRX cycle defined by the idle state eDRX configuration.

As the UE has the first eDRX cycle and the first DRX cycle at the same time, a measurement configuration for RRM measurement of the UE will be determined in combination with the first eDRX cycle and the first DRX cycle.

For example, the measurement configuration for RRM measurement may be determined according to Table 6 and Table 7. The measurement configuration may include: an RRM measurement configuration for a serving cell and/or a measurement configuration for RRM measurement of a neighboring cell. The neighboring cell here includes but is not limited to: an intra-frequency neighboring cell, an inter-frequency neighboring cell and/or an inter-system cell.

As shown in FIG. 6, an example of the disclosure provides an RRM measurement configuration determining apparatus 600, including a first determining module 610 and a second determining module 620.

The first determining module 610 is configured to determine relevant information according to a non-connected state of UE and an extended discontinuous reception eDRX configuration condition of the UE. Where the relevant information at least indicates: a first DRX cycle and whether the UE has a first eDRX cycle.

The second determining module 620 is configured to determine a measurement configuration of the UE for RRM measurement according to the relevant information.

In some examples, the first determining module 610 and the second determining module 620 may both be program modules; and the program modules include processors, and after execution, determination of the relevant information and determination of the measurement configuration can be achieved.

In some other examples, the first determining module 610 and the second determining module 620 may both be software-hardware combined modules, which include but are not limited to programmable arrays, and the programmable arrays include but are not limited to: a field programmable array or a complex programmable array.

In yet some other examples, the first determining module 610 and the second determining module 620 may both be pure-hardware modules which include: an application-specific integrated circuit.

In some examples, the first determining module 610 is configured to execute at least one of following: in response to that the UE is in an idle state, an idle state eDRX cycle of the UE is configured as a first cycle, and at least one of the UE and/or an anchor base station of the UE does not support the idle state eDRX cycle which is the first cycle, determining that the UE does not have the first eDRX cycle, and the first DRX cycle is equal to the idle state eDRX cycle; or in response to that the UE is in an inactive state, an inactive state eDRX cycle of the UE is configured as the first cycle, and at least one of the UE and/or the anchor base station of the UE does not support the inactive state eDRX cycle which is the first cycle, determining that the UE does not have the first eDRX cycle, and the first DRX cycle is equal to the inactive state eDRX cycle.

In some examples, the first determining module 610 is configured to execute at least one of following: in response to that the UE is in the inactive state, the idle state eDRX cycle of the UE is not greater than a second cycle, and the inactive state eDRX cycle of the UE is not configured, determining that the UE does not have the first eDRX cycle, and determining the first DRX cycle according to an idle state eDRX configuration of the UE; or in response to that the UE is in the idle state, the idle state eDRX cycle of the UE is not greater than the second cycle, and the inactive state eDRX cycle of the UE is not configured, determining that the UE has the first eDRX cycle which is equal to the idle state eDRX cycle, and determining the first DRX cycle according to the idle state eDRX configuration of the UE.

In some examples, the first determining module 610 is configured to: in response to that the UE is in the inactive state, an idle state cycle of the UE is not greater than the second cycle, the inactive state eDRX cycle of the UE is not configured, and the UE does not have the first eDRX cycle, determine that the first DRX cycle is equal to a smaller one of the idle state eDRX cycle and a radio access network RAN paging cycle.

In some examples, the first determining module 610 is configured to execute at least one of following: in response to that the UE is in the inactive state, the UE is configured with the idle state eDRX cycle and the inactive state eDRX cycle, and both the idle state eDRX cycle and the inactive state eDRX cycle are not greater than the second cycle, determining that the UE has the first eDRX cycle which is equal to a smaller one of the inactive state eDRX cycle and the idle state eDRX cycle, and determining the first DRX cycle as a third cycle or the first cycle; or in response to that the UE is in the inactive state, the UE is configured with the idle state eDRX cycle and the inactive state eDRX cycle, and both the idle state eDRX cycle and the inactive state eDRX cycle are not greater than the second cycle, determining that the UE has the first eDRX cycle which is equal to the inactive state eDRX cycle, and determining the first DRX cycle as the third cycle or the first cycle. Where the third cycle is an eDRX cycle smaller than the second cycle; and the first cycle is an eDRX cycle smaller than the third cycle.

In some examples, the first determining module 610 is configured to execute at least one of following: in response to that the UE is in the inactive state, the idle state eDRX cycle of the UE is greater than the second cycle, and the inactive state eDRX cycle is not configured, determining that the UE has the first eDRX cycle which is equal to the idle state eDRX cycle, and determining the first DRX cycle according to the idle state eDRX configuration of the UE; in response to that the UE is in the idle state, the idle state eDRX cycle of the UE is greater than the second cycle, and the inactive state eDRX cycle is not configured, determining that the UE has the first eDRX cycle which is equal to the idle state eDRX cycle, and determining the first DRX cycle according to the idle state eDRX configuration of the UE; or in response to that the UE is in the idle state, the idle state eDRX cycle of the UE is greater than the second cycle, and the inactive state eDRX cycle is not configured, determining that the UE does not have the first eDRX cycle, and determining the first DRX cycle according to the idle state eDRX configuration of the UE.

In some examples, the first determining module 610 is configured to execute at least one of following: in response to that the UE is in the inactive state, the idle state eDRX cycle of the UE is greater than the second cycle, and the inactive state eDRX cycle is not configured, determining that the UE has the first eDRX cycle which is equal to the idle state eDRX cycle, and determining that the first DRX cycle is a smaller one of an idle state DRX cycle defined by the idle state eDRX configuration and a default paging cycle; or in response to that the UE is in the inactive state, the idle state eDRX cycle of the UE is greater than the second cycle, and the inactive state eDRX cycle is not configured, determining that the UE has the first eDRX cycle which is equal to the idle state eDRX cycle, and determining that the first DRX cycle is a smallest one of the idle state DRX cycle defined by the idle state eDRX configuration, an RAN paging cycle defined by an inactive state eDRX configuration and the default paging cycle.

In some examples, the first determining module 610 is configured to: in response to that the UE is in the idle state, the idle state eDRX cycle of the UE is greater than the second cycle, and the inactive state eDRX cycle is not configured, determine that the UE has the first eDRX cycle which is equal to the idle state eDRX cycle, and determine that the first DRX cycle is a smaller one of the idle state DRX cycle defined by the idle state eDRX configuration and the default paging cycle.

In some examples, the first determining module 610 is configured to execute: in response to that the UE is in the idle state, the idle state eDRX cycle of the UE is greater than the second cycle, and the inactive state eDRX cycle is not configured, determining that the UE does not have the first eDRX cycle, and determining that the first DRX cycle is a smaller one of the idle state eDRX cycle defined by the idle state eDRX configuration and the RAN paging cycle.

In some examples, in response to that the UE is in the inactive state, the idle state eDRX cycle of the UE is greater than the second cycle, and the inactive state eDRX cycle is not configured, the UE has the first eDRX cycle which is equal to the idle state eDRX cycle, and RRM measurement of the UE is located within a paging time window PTW of the idle state eDRX cycle.

In some examples, in response to that the UE is in the idle state, the idle state eDRX cycle of the UE is greater than the second cycle, and the inactive state eDRX cycle is not configured, the UE has the first eDRX cycle which is equal to the idle state eDRX cycle, and RRM measurement of the UE is located within the paging time window PTW of the idle state eDRX cycle.

In some examples, the first determining module 610 is configured to execute at least one of following: in response to that the UE is in the idle state, the idle state eDRX cycle of the UE is greater than the second cycle, and the inactive state eDRX cycle not greater than the second cycle is configured, determining that the UE has the first eDRX cycle which is equal to the idle state eDRX cycle, and determining that the first DRX cycle is a smaller one of an eDRX cycle defined by the idle state eDRX configuration and the default paging cycle; in response to that the UE is in the inactive state, the idle state eDRX cycle of the UE is greater than the second cycle, and the inactive state eDRX cycle not greater than the second cycle is configured, determining that the UE has the first eDRX cycle which is equal to the idle state eDRX cycle, and determining the first DRX cycle according to the idle state eDRX configuration of the UE; or in response to that the UE is in the inactive state, the idle state eDRX cycle of the UE is greater than the second cycle, and the inactive state eDRX cycle not greater than the second cycle is configured, determining that the UE has the first eDRX cycle which is equal to a smaller one of the idle state eDRX cycle and the inactive state eDRX cycle, and determining the first DRX cycle according to the idle state eDRX configuration of the UE.

In some examples, the first determining module 610 is configured to: in response to that the UE is in the inactive state, the idle state eDRX cycle of the UE is greater than the second cycle, and the inactive state eDRX cycle not greater than the second cycle is configured, determine that the UE has the first eDRX cycle which is equal to the idle state eDRX cycle, and determine that the first DRX cycle is a smaller one of the idle state DRX cycle defined by the idle state eDRX configuration and the default paging cycle.

In some examples, the first determining module 610 is configured to: in response to that the UE is in the inactive state, the idle state eDRX cycle of the UE is greater than the second cycle, and the inactive state eDRX cycle not greater than the second cycle is configured, determine that the UE has the first eDRX cycle which is equal to the idle state eDRX cycle, and determine that the first DRX cycle is a smaller one of the idle state DRX cycle defined by the idle state eDRX configuration and the default paging cycle; or, in response to that the UE is in the inactive state, the idle state eDRX cycle of the UE is greater than the second cycle, and the inactive state eDRX cycle not greater than the second cycle is configured, determine that the UE has the first eDRX cycle which is equal to the idle state eDRX cycle, and determine that the first DRX cycle is a smallest one of the idle state DRX cycle defined by the idle state eDRX configuration, the RAN paging cycle defined by the inactive state eDRX configuration and the default paging cycle.

In some examples, the first determining module 610 is configured to: in response to that the UE is in the inactive state, the idle state eDRX cycle of the UE is greater than the second cycle, and the inactive state eDRX cycle not greater than the second cycle is configured, determine that the UE has the first eDRX cycle which is equal to a smaller one of the idle state eDRX cycle and the inactive state eDRX cycle, and determine that the first DRX cycle is a smaller one of the idle state DRX cycle defined by the idle state eDRX configuration and the default paging cycle; or, in response to that the UE is in the inactive state, the idle state eDRX cycle of the UE is greater than the second cycle, and the inactive state eDRX cycle not greater than the second cycle is configured, determine that the UE has the first eDRX cycle which is equal to a smaller one of the idle state eDRX cycle and the inactive state eDRX cycle, and determine that the first DRX cycle is a smaller one of the idle state DRX cycle defined by the idle state eDRX configuration and the RAN paging cycle defined by the inactive state eDRX configuration; or, in response to that the UE is in the inactive state, the idle state eDRX cycle of the UE is greater than the second cycle, and the inactive state eDRX cycle not greater than the second cycle is configured, determine that the UE has the first eDRX cycle which is equal to a smaller one of the idle state eDRX cycle and the inactive state eDRX cycle, and determine that the first DRX cycle is a smallest one of the idle state DRX cycle defined by the idle state eDRX configuration, the RAN paging cycle defined by the inactive state eDRX configuration and the default paging cycle.

In some examples, in response to that the UE is in the idle state, the idle state eDRX cycle of the UE is greater than the second cycle, and the inactive state eDRX cycle not greater than the second cycle is configured, it is determined that the UE has the first eDRX cycle which is equal to the idle state eDRX cycle, and measurement time of RRM measurement of the UE is located within the PTW of the idle state eDRX cycle.

In some examples, in response to that the UE is in the inactive state, the idle state eDRX cycle of the UE is greater than the second cycle, and the inactive state eDRX cycle not greater than the second cycle is configured, the UE has the first eDRX cycle which is equal to the idle state eDRX cycle, and the measurement time of RRM measurement of the UE is located within the PTW of the idle state eDRX cycle.

In some examples, the first determining module 610 is configured to execute at least one of following: in response to that the UE is in the idle state, the idle state eDRX cycle of the UE is greater than the second cycle, and the inactive state eDRX cycle greater than the second cycle is configured, determining that the UE has the first eDRX cycle which is equal to the idle state eDRX cycle, and determining that the first DRX cycle is a smaller one of the idle state DRX cycle defined by the idle state eDRX configuration and the default paging cycle; in response to that the UE is in the inactive state, the idle state eDRX cycle of the UE is greater than the second cycle, and the inactive state eDRX cycle greater than the second cycle is configured, determining that the UE has the first eDRX cycle which is equal to the idle state eDRX cycle, and determining the first DRX cycle according to the idle state eDRX configuration of the UE; in response to that the UE is in the inactive state, the idle state eDRX cycle of the UE is greater than the second cycle, and the inactive state eDRX cycle greater than the second cycle is configured, determining that the UE has the first eDRX cycle which is equal to the inactive state eDRX cycle, and determining the first DRX cycle according to the inactive state eDRX configuration of the UE; or in response to that the UE is in the inactive state, the idle state eDRX cycle of the UE is greater than the second cycle, and the inactive state eDRX cycle greater than the second cycle is configured, determining that the UE has the first eDRX cycle which is equal to a smaller one of the idle state eDRX cycle and the inactive state eDRX cycle, and determining the first DRX cycle according to the idle state eDRX configuration and the inactive state eDRX configuration of the UE.

In some examples, the first determining module 610 is configured to: in response to that the UE is in the inactive state, the idle state eDRX cycle of the UE is greater than the second cycle, and the inactive state eDRX cycle greater than the second cycle is configured, determine that the UE has the first eDRX cycle which is equal to the idle state eDRX cycle, and determine that the first DRX cycle is a smaller one of the RAN paging cycle defined by the inactive state eDRX configuration and the default paging cycle; or in response to that the UE is in the inactive state, the idle state eDRX cycle of the UE is greater than the second cycle, and the inactive state eDRX cycle greater than the second cycle is configured, determine that the UE has the first eDRX cycle which is equal to the idle state eDRX cycle, and determine that the first DRX cycle is a smallest one of the idle state DRX cycle defined by the idle state eDRX configuration, the RAN paging cycle defined by the inactive state eDRX configuration and the default paging cycle.

In some examples, the first determining module 610 is configured to: in response to that the UE is in the inactive state, the idle state eDRX cycle of the UE is greater than the second cycle, and the inactive state eDRX cycle greater than the second cycle is configured, determine that the UE has the first eDRX cycle which is equal to the inactive state eDRX cycle, and determine that the first DRX cycle is a smallest one of the idle state DRX cycle defined by the idle state eDRX configuration, the default paging cycle and the RAN paging cycle defined by the inactive state eDRX configuration; or in response to that the UE is in the inactive state, the idle state eDRX cycle of the UE is greater than the second cycle, and the inactive state eDRX cycle greater than the second cycle is configured, determine that the UE has the first eDRX cycle which is equal to the inactive state eDRX cycle, and determine that the first DRX cycle is a smaller one of the default paging cycle and the RAN paging cycle defined by the inactive state eDRX configuration; or in response to that the UE is in the inactive state, the idle state eDRX cycle of the UE is greater than the second cycle, and the inactive state eDRX cycle greater than the second cycle is configured, determine that the UE has the first eDRX cycle which is equal to the inactive state eDRX cycle, and determine that the first DRX cycle is the RAN paging cycle defined by the inactive state eDRX configuration.

In some examples, in response to that the UE is in the idle state, the idle state eDRX cycle of the UE is greater than the second cycle, and the inactive state eDRX cycle greater than the second cycle is configured, the UE has the first eDRX cycle which is equal to the idle state eDRX cycle, and the measurement time of RRM measurement of the UE is located within the PTW of the idle state eDRX cycle.

In one example, in response to that the UE is in the inactive state, the idle state eDRX cycle of the UE is greater than the second cycle, and the inactive state eDRX cycle greater than the second cycle is configured, the UE has the first eDRX cycle which is equal to the idle state eDRX cycle, and the measurement time of RRM measurement of the UE is located within the PTW of the idle state eDRX cycle.

In some examples, in response to that the UE is in the inactive state, the idle state eDRX cycle of the UE is greater than the second cycle, and the inactive state eDRX cycle greater than the second cycle is configured, the UE has the first eDRX cycle which is equal to the inactive state eDRX cycle, and RRM measurement time of the UE is located within a PTW of the inactive state eDRX cycle.

In some examples, in response to that the UE is in the inactive state, the idle state eDRX cycle of the UE is greater than the second cycle and the inactive state eDRX cycle greater than the second cycle is configured, the UE has the first eDRX cycle which is equal to a smaller one of the idle state eDRX cycle and the inactive state eDRX cycle, and time of RRM measurement is located within a smaller one of the PTW of the idle state eDRX cycle and the PTW of the inactive state eDRX cycle.

In some examples, the second determining module 620 is configured to: in response to that the UE does not have the first eDRX cycle, determine the measurement configuration for RRM measurement according to the first DRX cycle; or, in response to that the UE has the first eDRX cycle and the first DRX cycle, determine the measurement configuration for RRM measurement according to the first eDRX cycle and the first DRX cycle.

In some examples, the second determining module 620 is configured to: in response to that the UE has the first eDRX cycle and the first DRX cycle, and the UE has a first PTW, determine a measurement configuration for RRM measurement performed within the first PTW according to the first eDRX cycle, the first DRX cycle and the first PTW; or

in response to that the UE has the first eDRX cycle and the first DRX cycle, and the UE does not have the first PTW, determine a measurement configuration for RRM measurement performed within a time domain according to the first eDRX cycle and the first DRX cycle.

The first PTW is the PTW of the idle state eDRX cycle or the inactive state eDRX cycle which is equal to the first eDRX cycle.

In some examples, the measurement configuration for RRM measurement includes at least one of the following: a measurement cycle Nserv of RRM measurement for a serving cell of the UE; or a detection cycle, a measurement cycle and/or an evaluation cycle of RRM measurement for a neighboring cell of the UE.

In some examples, a duration of the first cycle is 2.56 s.

An example of the disclosure provides a communication device, including: a memory, configured to store processor-executable instructions; and a processor, connected with the memory. Where the processor is configured to execute the RRM measurement configuration determining method provided by any aforementioned technical solution.

The processor may include storage media of various types. The storage media are non-temporary computer storage media and can continue to memorize information stored after the communication device is powered down.

Here, the communication device includes: an access device or UE.

The processor may be connected with the memory through a bus and the like and is configured to read an executable program stored on the memory, such as at least one of the RRM measurement configuration determining methods as shown in FIG. 3 to FIG. 5.

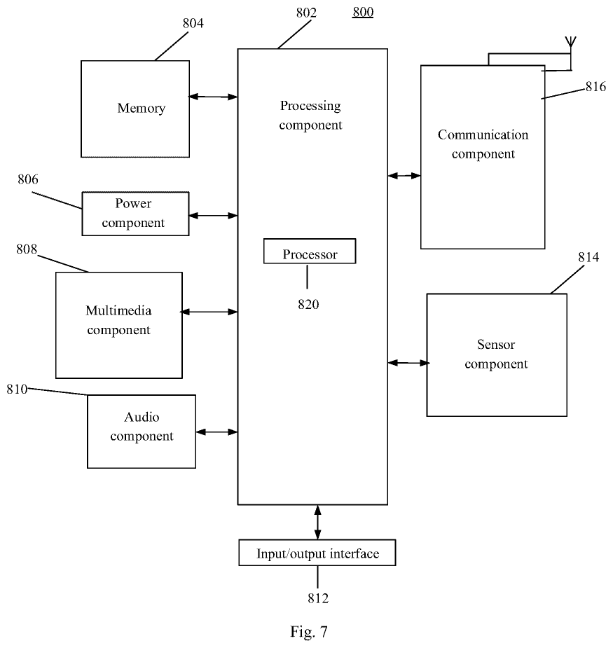

FIG. 7 is a block diagram of UE 800 illustrated according to an example. For example, the UE 800 may be a mobile phone, a computer, digital broadcasting user equipment, a messaging device, a game console, a tablet device, a medical device, a fitness device, a personal digital assistant, etc.

Referring to FIG. 7, the UE 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls the overall operation of the UE 800, such as operations associated with display, telephone call, data communication, camera operations, and recording operations. The processing component 802 may include one or more processors 820 to execute instructions to complete all or part of the steps of the above method. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations at the UE 800. Examples of these data include instructions for any application or method operating on the UE 800, contact data, phonebook data, messages, pictures, videos, etc. The memory 804 may be implemented by any type of volatile or nonvolatile storage device or their combinations, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or optic disk.

The power component 806 provides power for various components of the UE 800. The power component 806 may include a power management system, one or more power sources and other components associated with generating, managing and distributing power for the UE 800.

The multimedia component 808 includes a screen providing an output interface between the UE 800 and a user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense touch, sliding and gestures on the touch panel. The touch sensor can not only sense the boundary of the touch or sliding operation, but also detect the duration and pressure related to the touch or sliding operation. In some examples, the multimedia component 808 includes a front camera and/or a rear camera. When the UE 800 is in an operation mode, such as a shooting mode or a video mode, the front camera and/or the rear camera may receive external multimedia data. Each front camera and rear camera may be a fixed optical lens system or have a focal length and optical zoom capability.

The audio component 810 is configured to output and/or input audio signals. For example, the audio component 810 includes a microphone (MIC) configured to receive an external audio signal when the UE 800 is in the operation mode, such as a call mode, a recording mode, and a speech recognition mode. The received audio signal may be further stored in the memory 804 or transmitted via the communication component 816. In some examples, the audio component 810 also includes a speaker for outputting an audio signal.

The I/O interface 812 provides an interface between the processing component 802 and a peripheral interface module which may be a keyboard, a click wheel, a button, etc. These buttons may include but are not limited to: a home button, volume buttons, a start button and a lock button.

The sensor component 814 includes one or more sensors for providing state evaluation of various aspects of the UE 800. For example, the sensor component 814 may detect an on/off state of the UE 800 and the relative positioning of the components, for example, the component is a display and a keypad of the UE 800. The sensor component 814 may also detect the change of the position of the UE 800 or one component of the UE 800, the presence or absence of user contact with the UE 800, the azimuth or acceleration/deceleration of the UE 800, and temperature change of the UE 800. The sensor component 814 may include a proximity sensor configured to detect the presence of nearby objects without any physical contact. The sensor component 814 may further include an optical sensor, such as a CMOS or CCD image sensor, for use in imaging applications. In some examples, the sensor component 814 may further include an acceleration sensor, a gyroscope sensor, a magnetic sensor, a pressure sensor, or a temperature sensor.

The communication component 816 is configured to facilitate wired or wireless communication between the UE 800 and other devices. The UE 800 may access a wireless network based on a communication standard, such as WiFi, 2G or 3G, or their combinations. In an example, the communication component 816 receives a broadcast signal or broadcast-related information from an external broadcast management system via a broadcast channel. In an example, the communication component 816 further includes a near field communication (NFC) module to facilitate short-range communication. For example, the NFC module may be implemented based on a radio frequency identification (RFID) technology, an infrared data association (IrDA) technology, an ultra wideband (UWB) technology, a Bluetooth (BT) technology and other technologies.

In an example, the UE 800 may be implemented by one or more application-specific integrated circuits (ASIC), digital signal processors (DSP), digital signal processing devices (DSPD), programmable logic devices (PLD), field programmable gate arrays (FPGA), controllers, microcontrollers, microprocessors, or other electronic elements for executing the above method.

In an example, a non-temporary computer readable storage medium including instructions, such as the memory 804 including instructions, which may be executed by the processor 820 of the UE 800 to complete the above method, is also provided. For example, the non-temporary computer readable storage medium may be a ROM, a random access memory (RAM), a CD-ROM, a magnetic tape, a floppy disk, an optical data storage device, etc.

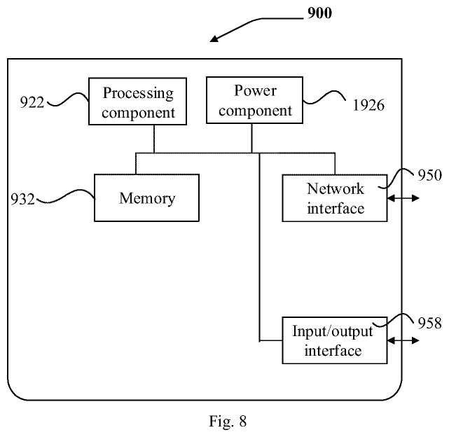

As shown in FIG. 8, an example of the disclosure shows a structure of an access device. For example, the communication device 900 may be provided as a network side device. The communication device 900 may be the aforementioned access device and/or core network device.

Referring to FIG. 8, the communication device 900 includes a processing component 922, which further includes one or more processors (not shown), and a memory resource represented by a memory 932 for storing instructions, such as applications, that may be executed by the processing component 922. The applications stored in the memory 932 may include one or more modules each corresponding to a set of instructions. In addition, the processing component 922 is configured to execute instructions to execute any method applied to the access device above, such as the RRM configuration determining method as shown in FIG. 2 and FIG. 3 to FIG. 5.

The communication device 900 may further include a power component 926 configured to execute power management of the communication device 900, a wired or wireless network interface 950 configured to connect the communication device 900 to the network, and an input/output (I/O) interface 958. The communication device 900 may operate an operating system stored in the memory 932, such as Windows Server™, Mac OS X™, Unix™, Linux™, FreeBSD™, or the like.

Other embodiment solutions of the disclosure will be apparent to those skilled in the art from consideration of the specification and practice of the disclosure here. The disclosure is intended to cover any variations, uses, or adaptations of the disclosure following the general principles thereof and including such departures from the disclosure as come within known or customary practice in the art. It is intended that the specification and examples be considered as exemplary only, with a true scope and spirit of the disclosure being indicated by the following claims.

It will be appreciated that the disclosure is not limited to the exact construction that has been described above and illustrated in the accompanying drawings, and that various modifications and changes may be made without departing from the scope thereof. It is intended that the scope of the disclosure only be limited by the appended claims.

1. A radio resource management (RRM) measurement configuration determining method, executed by user equipment (UE), and comprising:
determining relevant information according to a non-connected state of the UE and an extended discontinuous reception (eDRX) configuration condition of the UE, wherein the relevant information at least indicates: a first discontinuous reception (DRX) cycle and whether the UE has a first eDRX cycle; and
determining a measurement configuration of the UE for the RRM measurement according to the relevant information.

2. The method according to claim 1, wherein determining the relevant information according to the non-connected state of the UE and the eDRX configuration condition of the UE comprises at least one of:
in response to the UE being in an idle state, an idle state eDRX cycle of the UE is configured as a first cycle and at least one of the UE or an anchor base station of the UE does not support the idle state eDRX cycle which is the first cycle, determining that the UE does not have the first eDRX cycle, and the first DRX cycle is equal to the idle state eDRX cycle;
in response to the UE being in an inactive state, an inactive state eDRX cycle of the UE is configured as the first cycle and at least one of the UE or the anchor base station of the UE does not support the inactive state eDRX cycle which is the first cycle, determining that the UE does not have the first eDRX cycle, and the first DRX cycle is equal to the inactive state eDRX cycle;
in response to the UE being in the inactive state, the idle state eDRX cycle of the UE is not greater than a second cycle and the inactive state eDRX cycle of the UE is not configured, determining that the UE does not have the first eDRX cycle, and determining the first DRX cycle according to an idle state eDRX configuration of the UE; or
in response to the UE being in the idle state, the idle state eDRX cycle of the UE is not greater than the second cycle and the inactive state eDRX cycle of the UE is not configured, determining that the UE has the first eDRX cycle which is equal to the idle state eDRX cycle, and determining the first DRX cycle according to the idle state eDRX configuration of the UE.

3. (canceled)

4. The method according to claim 2, wherein in response to the UE being in the inactive state, the idle state eDRX cycle of the UE is not greater than a second cycle and the inactive state eDRX cycle of the UE is not configured, determining that the UE does not have the first eDRX cycle, and determining the first DRX cycle according to an idle state eDRX configuration of the UE, comprises:
in response to that the UE is in the inactive state, an idle state cycle of the UE is not greater than the second cycle, the inactive state eDRX cycle of the UE is not configured and the UE does not have the first eDRX cycle, determining that the first DRX cycle is equal to a smaller one of the idle state eDRX cycle and a radio access network (RAN) paging cycle.

5. The method according to claim 1, wherein
determining the relevant information according to the non-connected state of the UE and the eDRX configuration condition of the UE further comprises:
in response to the UE being in the inactive state, the UE is configured with the idle state eDRX cycle and the inactive state eDRX cycle, and both the idle state eDRX cycle and the inactive state eDRX cycle are not greater than a second cycle, determining that the UE has the first eDRX cycle which is equal to a smaller one of the inactive state eDRX cycle and the idle state eDRX cycle, and determining the first DRX cycle as a third cycle or the first cycle; or
in response to the UE being in the inactive state, the UE is configured with the idle state eDRX cycle and the inactive state eDRX cycle, and both the idle state eDRX cycle and the inactive state eDRX cycle are not greater than the second cycle, determining that the UE has the first eDRX cycle which is equal to the inactive state eDRX cycle, and determining the first DRX cycle as the third cycle or the first cycle; wherein
the third cycle is an eDRX cycle smaller than the second cycle; and the first cycle is an eDRX cycle smaller than the third cycle;
determining the relevant information according to the non-connected state of the UE and the eDRX configuration condition of the UE further comprises at least one of:
in response to the UE being in the inactive state, the idle state eDRX cycle of the UE is greater than the second cycle and the inactive state eDRX cycle is not configured, determining that the UE has the first eDRX cycle which is equal to the idle state eDRX cycle, and determining the first DRX cycle according to the idle state eDRX configuration of the UE;
in response to the UE being in the idle state, the idle state eDRX cycle of the UE is greater than the second cycle and the inactive state eDRX cycle is not configured, determining that the UE has the first eDRX cycle which is equal to the idle state eDRX cycle, and determining the first DRX cycle according to the idle state eDRX configuration of the UE; or
in response to the UE being in the idle state, the idle state eDRX cycle of the UE is greater than the second cycle and the inactive state eDRX cycle is not configured, determining that the UE does not have the first eDRX cycle, and determining the first DRX cycle according to the idle state eDRX configuration of the UE.

6. (canceled)

7. The method according to claim 5, wherein in response to the UE being in the inactive state, the idle state eDRX cycle of the UE is greater than the second cycle and the inactive state eDRX cycle is not configured, determining that the UE has the first eDRX cycle which is equal to the idle state eDRX cycle, and determining the first DRX cycle according to the idle state eDRX configuration of the UE, comprises:
in response to the UE being in the inactive state, the idle state eDRX cycle of the UE is greater than the second cycle and the inactive state eDRX cycle is not configured, determining that the UE has the first eDRX cycle which is equal to the idle state eDRX cycle, and determining that the first DRX cycle is a smaller one of an idle state DRX cycle defined by the idle state eDRX configuration and a default paging cycle; or,
in response to the UE being in the inactive state, the idle state eDRX cycle of the UE is greater than the second cycle and the inactive state eDRX cycle is not configured, determining that the UE has the first eDRX cycle which is equal to the idle state eDRX cycle, and determining that the first DRX cycle is a smallest one of the idle state DRX cycle defined by the idle state eDRX configuration, an RAN paging cycle defined by an inactive state eDRX configuration and the default paging cycle.

8. The method according to claim 5, wherein in response to the UE being in the idle state, the idle state eDRX cycle of the UE is greater than the second cycle and the inactive state eDRX cycle is not configured, determining that the UE has the first eDRX cycle which is equal to the idle state eDRX cycle, and determining the first DRX cycle according to the idle state eDRX configuration of the UE, comprises:
in response to the UE being in the idle state, the idle state eDRX cycle of the UE is greater than the second cycle and the inactive state eDRX cycle is not configured, determining that the UE has the first eDRX cycle which is equal to the idle state eDRX cycle, and determining that the first DRX cycle is a smaller one of an idle state DRX cycle defined by the idle state eDRX configuration and a default paging cycle.

9. The method according to claim 5, wherein in response to the UE being in the idle state, the idle state eDRX cycle of the UE is greater than the second cycle and the inactive state eDRX cycle is not configured, determining that the UE does not have the first eDRX cycle, and determining the first DRX cycle according to the idle state eDRX configuration of the UE, comprises:
in response to the UE being in the idle state, the idle state eDRX cycle of the UE is greater than the second cycle and the inactive state eDRX cycle is not configured, determining that the UE does not have the first eDRX cycle, and determining that the first DRX cycle is a smaller one of an idle state eDRX cycle defined by the idle state eDRX configuration and an RAN paging cycle.

10. The method according to claim 5, wherein in response to the UE being in the inactive state, the idle state eDRX cycle of the UE is greater than the second cycle and the inactive state eDRX cycle is not configured, the UE has the first eDRX cycle which is equal to the idle state eDRX cycle, and RRM measurement of the UE is located within a paging time window (PTW) of the idle state eDRX cycle;
wherein in response to the UE being in the idle state, the idle state eDRX cycle of the UE is greater than the second cycle and the inactive state eDRX cycle is not configured, the UE has the first eDRX cycle which is equal to the idle state eDRX cycle, and RRM measurement of the UE is located within a PTW of the idle state eDRX cycle.

11. (canceled)

12. The method according to claim 1, wherein determining the relevant information according to the non-connected state of the UE and the eDRX configuration condition of the UE further comprises at least one of the following:
in response to the UE being in an idle state, the idle state eDRX cycle of the UE is greater than the second cycle and the inactive state eDRX cycle not greater than the second cycle is configured, determining that the UE has the first eDRX cycle which is equal to the idle state eDRX cycle, and determining that the first DRX cycle is a smaller one of an eDRX cycle defined by the idle state eDRX configuration and the default paging cycle;
in response to the UE being in an inactive state, the idle state eDRX cycle of the UE is greater than the second cycle and the inactive state eDRX cycle not greater than the second cycle is configured, determining that the UE has the first eDRX cycle which is equal to the idle state eDRX cycle, and determining the first DRX cycle according to the idle state eDRX configuration of the UE; or
in response to the UE being in the inactive state, the idle state eDRX cycle of the UE is greater than the second cycle and the inactive state eDRX cycle not greater than the second cycle is configured, determining that the UE has the first eDRX cycle which is equal to a smaller one of the idle state eDRX cycle and the inactive state eDRX cycle, and determining the first DRX cycle according to the idle state eDRX configuration of the UE.

13. (canceled)

14. The method according to claim 12, wherein in response to the UE being in the inactive state, the idle state eDRX cycle of the UE is greater than the second cycle and the inactive state eDRX cycle not greater than the second cycle is configured, determining that the UE has the first eDRX cycle which is equal to the idle state eDRX cycle, and determining the first DRX cycle according to the idle state eDRX configuration of the UE, comprises:
in response to the UE being in the inactive state, the idle state eDRX cycle of the UE is greater than the second cycle and the inactive state eDRX cycle not greater than the second cycle is configured, determining that the UE has the first eDRX cycle which is equal to the idle state eDRX cycle, and determining that the first DRX cycle is a smaller one of the idle state DRX cycle defined by the idle state eDRX configuration and the default paging cycle; or,
in response to the UE being in the inactive state, the idle state eDRX cycle of the UE is greater than the second cycle and the inactive state eDRX cycle not greater than the second cycle is configured, determining that the UE has the first eDRX cycle which is equal to the idle state eDRX cycle, and determining that the first DRX cycle is a smallest one of the idle state DRX cycle defined by the idle state eDRX configuration, the RAN paging cycle defined by the inactive state eDRX configuration and the default paging cycle.

15. The method according to claim 12, wherein in response to the UE being in the inactive state, the idle state eDRX cycle of the UE is greater than the second cycle and the inactive state eDRX cycle not greater than the second cycle is configured, determining that the UE has the first eDRX cycle which is equal to a smaller one of the idle state eDRX cycle and the inactive state eDRX cycle, and determining the first DRX cycle according to the idle state eDRX configuration of the UE, comprises:
in response to the UE being in the inactive state, the idle state eDRX cycle of the UE is greater than the second cycle and the inactive state eDRX cycle not greater than the second cycle is configured, determining that the UE has the first eDRX cycle which is equal to a smaller one of the idle state eDRX cycle and the inactive state eDRX cycle, and determining that the first DRX cycle is a smaller one of the idle state DRX cycle defined by the idle state eDRX configuration and the default paging cycle; or,
in response to the UE being in the inactive state, the idle state eDRX cycle of the UE is greater than the second cycle and the inactive state eDRX cycle not greater than the second cycle is configured, determining that the UE has the first eDRX cycle which is equal to a smaller one of the idle state eDRX cycle and the inactive state eDRX cycle, and determining that the first DRX cycle is a smaller one of the idle state DRX cycle defined by the idle state eDRX configuration and the RAN paging cycle defined by the inactive state eDRX configuration; or,
in response to the UE being in the inactive state, the idle state eDRX cycle of the UE is greater than the second cycle and the inactive state eDRX cycle not greater than the second cycle is configured, determining that the UE has the first eDRX cycle which is equal to a smaller one of the idle state eDRX cycle and the inactive state eDRX cycle, and determining that the first DRX cycle is a smallest one of the idle state DRX cycle defined by the idle state eDRX configuration, the RAN paging cycle defined by the inactive state eDRX configuration and the default paging cycle.

16. The method according to claim 12, wherein
in response to the UE being in the idle state, the idle state eDRX cycle of the UE is greater than the second cycle and the inactive state eDRX cycle not greater than the second cycle is configured, it is determined that the UE has the first eDRX cycle which is equal to the idle state eDRX cycle, and measurement time of RRM measurement of the UE is located within the PTW of the idle state eDRX cycle;
wherein in response to the UE being in the inactive state, the idle state eDRX cycle of the UE is greater than the second cycle and the inactive state eDRX cycle not greater than the second cycle is configured, the UE has the first eDRX cycle which is equal to the idle state eDRX cycle, and measurement time of RRM measurement of the UE is located within the PTW of the idle state eDRX cycle.

17. (canceled)

18. The method according to claim 1, wherein determining the relevant information according to the non-connected state of the UE and the eDRX configuration condition of the UE further comprises at least one of the following:
in response to the UE being in an idle state, the idle state eDRX cycle of the UE is greater than the second cycle and the inactive state eDRX cycle greater than the second cycle is configured, determining that the UE has the first eDRX cycle which is equal to the idle state eDRX cycle, and determining that the first DRX cycle is a smaller one of the idle state DRX cycle defined by the idle state eDRX configuration and the default paging cycle;
in response to the UE being in an inactive state, the idle state eDRX cycle of the UE is greater than the second cycle and the inactive state eDRX cycle greater than the second cycle is configured, determining that the UE has the first eDRX cycle which is equal to the idle state eDRX cycle, and determining the first DRX cycle according to the idle state eDRX configuration of the UE;
in response to the UE being in the inactive state, the idle state eDRX cycle of the UE is greater than the second cycle and the inactive state eDRX cycle greater than the second cycle is configured, determining that the UE has the first eDRX cycle which is equal to the inactive state eDRX cycle, and determining the first DRX cycle according to the inactive state eDRX configuration of the UE; or
in response to the UE being in the inactive state, the idle state eDRX cycle of the UE is greater than the second cycle and the inactive state eDRX cycle greater than the second cycle is configured, determining that the UE has the first eDRX cycle which is equal to a smaller one of the idle state eDRX cycle and the inactive state eDRX cycle, and determining the first DRX cycle according to the idle state eDRX configuration and the inactive state eDRX configuration of the UE.

19. The method according to claim 18, wherein in response to the UE being in the inactive state, the idle state eDRX cycle of the UE is greater than the second cycle and the inactive state eDRX cycle greater than the second cycle is configured, determining that the UE has the first eDRX cycle which is equal to the idle state eDRX cycle, and determining the first DRX cycle according to the idle state eDRX configuration of the UE, comprises:
in response to the UE being in the inactive state, the idle state eDRX cycle of the UE is greater than the second cycle and the inactive state eDRX cycle greater than the second cycle is configured, determining that the UE has the first eDRX cycle which is equal to the idle state eDRX cycle, and determining that the first DRX cycle is a smaller one of the RAN paging cycle defined by the inactive state eDRX configuration and the default paging cycle; or,
in response to the UE being in the inactive state, the idle state eDRX cycle of the UE is greater than the second cycle and the inactive state eDRX cycle greater than the second cycle is configured, determining that the UE has the first eDRX cycle which is equal to the idle state eDRX cycle, and determining that the first DRX cycle is a smallest one of the idle state DRX cycle defined by the idle state eDRX configuration, the RAN paging cycle defined by the inactive state eDRX configuration and the default paging cycle.

20. The method according to claim 18, wherein in response to the UE being in the inactive state, the idle state eDRX cycle of the UE is greater than the second cycle and the inactive state eDRX cycle greater than the second cycle is configured, determining that the UE has the first eDRX cycle which is equal to a smaller one of the idle state eDRX cycle and the inactive state eDRX cycle, and determining the first DRX cycle according to the idle state eDRX configuration and the inactive state eDRX configuration of the UE, comprises:
in response to the UE being in the inactive state, the idle state eDRX cycle of the UE is greater than the second cycle and the inactive state eDRX cycle greater than the second cycle is configured, determining that the UE has the first eDRX cycle which is equal to the smaller one of the idle state eDRX cycle and the inactive state eDRX cycle, and determining that the first DRX cycle is a smallest one of the idle state DRX cycle defined by the idle state eDRX configuration, the default paging cycle and the RAN paging cycle defined by the inactive state eDRX configuration; or,
in response to the UE being in the inactive state, the idle state eDRX cycle of the UE is greater than the second cycle and the inactive state eDRX cycle greater than the second cycle is configured, determining that the UE has the first eDRX cycle which is equal to the smaller one of the idle state eDRX cycle and the inactive state eDRX cycle, and determining that the first DRX cycle is a smaller one of the default paging cycle and the RAN paging cycle defined by the inactive state eDRX configuration; or,
in response to the UE being in the inactive state, the idle state eDRX cycle of the UE is greater than the second cycle and the inactive state eDRX cycle greater than the second cycle is configured, determining that the UE has the first eDRX cycle which is equal to the smaller one of the idle state eDRX cycle and the inactive state eDRX cycle, and determining that the first DRX cycle is the RAN paging cycle defined by the inactive state eDRX configuration.

21. The method according to claim 18, wherein in response to the UE being in the idle state, the idle state eDRX cycle of the UE is greater than the second cycle and the inactive state eDRX cycle greater than the second cycle is configured, the UE has the first eDRX cycle which is equal to the idle state eDRX cycle, and measurement time of RRM measurement of the UE is located within the PTW of the idle state eDRX cycle;
wherein in response to the UE being in the inactive state, the idle state eDRX cycle of the UE is greater than the second cycle and the inactive state eDRX cycle greater than the second cycle is configured, the UE has the first eDRX cycle which is equal to the idle state eDRX cycle, and measurement time of RRM measurement of the UE is located within the PTW of the idle state eDRX cycle.

22. (canceled)

23. The method according to claim 18, wherein
in response to the UE being in the inactive state, the idle state eDRX cycle of the UE is greater than the second cycle and the inactive state eDRX cycle greater than the second cycle is configured, the UE has the first eDRX cycle which is equal to the inactive state eDRX cycle, and RRM measurement time of the UE is located within a PTW of the inactive state eDRX cycle;
wherein in response to the UE being in the inactive state, the idle state eDRX cycle of the UE is greater than the second cycle and the inactive state eDRX cycle greater than the second cycle is configured, the UE has the first eDRX cycle which is equal to a smaller one of the idle state eDRX cycle and the inactive state eDRX cycle, and time of RRM measurement is located within a smaller one of the PTW of the idle state eDRX cycle and a PTW of the inactive state eDRX cycle.

24. (canceled)

25. The method according to claim 1, wherein determining the measurement configuration of the UE for the RRM measurement according to the relevant information comprises:
in response to the UE not having the first eDRX cycle,
determining the measurement configuration for RRM measurement according to the first DRX cycle; or,
in response to the UE having the first eDRX cycle and the first DRX cycle, determining the measurement configuration for RRM measurement according to the first eDRX cycle and the first DRX cycle.

26. The method according to claim 25, wherein in response to the UE having the first eDRX cycle and the first DRX cycle, determining the measurement configuration for RRM measurement according to the first eDRX cycle and the first DRX cycle comprises:
in response to the UE having the first eDRX cycle and the first DRX cycle and the UE has a first PTW, determining a measurement configuration for RRM measurement performed within the first PTW according to the first eDRX cycle, the first DRX cycle and the first PTW; or,
in response to the UE having the first eDRX cycle and the first DRX cycle and the UE does not have the first PTW, determining a measurement configuration for RRM measurement performed within a time domain according to the first eDRX cycle and the first DRX cycle; wherein
the first PTW is the PTW of the idle state eDRX cycle or the inactive state eDRX cycle which is equal to the first eDRX cycle.

27-29. (canceled)

30. A communication device, comprising a processor, a transceiver, a memory and an executable program stored on the memory and capable of being operated by the processor, when the executable program is operated by the processor, the processor is caused to:
determine relevant information according to a non-connected state of user equipment (UE) and an extended discontinuous reception (eDRX) configuration condition of the UE, wherein the relevant information at least indicates: a first discontinuous reception (DRX) cycle and whether the UE has a first eDRX cycle; and
determine a measurement configuration of the UE for a radio resource management (RRM) measurement according to the relevant information.

31. (canceled)
